(19) United States
(12) Patent Application Publication
(10) Pub. No.: US 2014/0200954 A1
(43) Pub. Date: Jul. 17, 2014

(54) RESEARCH AND DEVELOPMENT AND MARKET VIABILITY ANALYSIS FRAMEWORK FOR DRUGS, BIOLOGICS AND MEDICAL DEVICES

(71) Applicant: Patricia TRIFUNOV, Wynnewood, PA (US)

(72) Inventor: Patricia TRIFUNOV, Wynnewood, PA (US)

(73) Assignee: GEAR FIVE HEALTH SOLUTIONS, INC., Wynnewood, PA (US)

(21) Appl. No.: 14/217,048

(22) Filed: Mar. 17, 2014

Related U.S. Application Data
(63) Continuation-in-part of application No. 13/286,184, filed on Oct. 31, 2011, now Pat. No. 8,719,051.
(60) Provisional application No. 61/800,492, filed on Mar. 15, 2013.

(51) Int. Cl. G06Q 10/06

(52) U.S. Cl. CPC G06Q 10/06375; G06Q 10/0635
USPC 705/7.28

(57) ABSTRACT

A drug, biologic or medical device evaluation software tool for determining optimized research, development and commercialization pathways. The method comprises a) providing comparative clinical trial, value proposition and marketplace success predictors as metrics from a selected range of therapeutically relevant marketplace competitors anticipated at the time of the launch of the new product to a computer device b) assigning comparative benefit and risk scores to the product in research and development relative to these competitors c) incorporating specific feedback from physicians, health plans, healthcare service providers and payers to validate these scores d) offering scenario planning on multiple research, development and marketing options based on theoretical benefit and risk alternative scoring, and refined through various metric weighting and apportioning functions within the tool.

### CROSS-REFERENCE TO RELATED APPLICATIONS

The present application is related to and claims priority from provisional application Ser. No. 61/432,518 filed on Jan. 13, 2011, entitled “Medical Assessment and Pricing Tool”, and is a continuation-in-part of patent application Ser. No. 13/286,184 filed on Oct. 31, 2011, entitled “System and Method for Evaluating and Comparing Medical Treatment”, and prior provisional patent application Ser. No. 61/800,492, filed on Mar. 15, 2013, entitled “Research and Development and Market Viability Analysis Framework for Drugs, Biologics and Medical Devices” all by Pat Trifunov, the contents which are incorporated herein by reference.

### FIELD OF THE INVENTION

The present invention relates to a software tool useful for evaluating a drug, biologic or medical device in research or in assessing the feasibility of continued investment against a plurality of currently available marketplace competitors for the purpose of determining its likelihood of meeting research and development and other goals, and eventually achieving future marketplace success. The invention also allows medical product developers to estimate potential pricing of products in development through the scoring of key medical efficacy, value proposition and marketplace contributors to calculate market price. Finally, potential users of the evaluated product(s), such as target populations and their uptake rates into markets can be tracked over time to determine both market valuation and return on investment.

### BACKGROUND

It is estimated that the cost to bring a new drug to market is, on average, about $800 million. However, despite the large investment involved, assessing a drug, biologic or medical device's potential for commercialization success and return on investment is often elusive. Moreover, the health care industry is noted for having a culture that fosters an inefficient decision making process. As such, many of these innovations in the last several years have failed to live up to initial expectations of FDA approval rates, commercialization success and estimates of potential market valuation and return on investment.

Although market forecast models are available, they do not have the ability to measure, weight, and integrate the critical factors that come into play in the development of a drug, biologic or medical device relative to their currently marketed competitors. Furthermore, most of the other software tools that exist in the pharmaceutical industry are designed for use in a particular area. For instance, research-related software has been built to specifically address research needs. Likewise, commercial software products respond only to sales and marketing needs of currently marketed products.

### SUMMARY

In a preferred embodiment of the present invention, the present invention comprises a computer system including non-transitory computer-readable memory that stores one or more code segments (i.e., a computer program) including the software of the invention executable by the computer system. When executed on the computer system, the present invention transforms the computer system into a software tool useful for drug, biologic or medical device in research against a plurality of currently available marketplace competitors for the purpose of determining its likelihood of meeting research and development goals, and eventually achieving future marketplace success. This success can be tracked over time for specific populations as identified by biomarkers, study parameters (including use limitations) and market uptake patterns.

The present invention can be used to facilitate decision making in the assessment, investment and/or development of a proposed new technology in research by modeling risk benefit ratio scenarios of the “target product profile”, relative to other comparable marketed or emerging technologies. The “target product profile” is a strategic document of a drug, biologic or medical device used by an inventor to chart the pathway for successful invention, by outlining the minimum standards for success required for continued research program investment. This profile can be followed all the way through until product launch and can guide the drug, biologic or device developer on the best strategic pathway to successful commercialization. This strategic pathway is achieved by attempting to mold the product to defined benefits and risks that the marketplace—including physicians, patients, payers, healthcare service providers and governments—has defined as the “standard of care.” The standard of care may exist as narrowly-defined treatment guidelines and/or protocols for use issued by government, non-profit, academic, or even leading private sector bodies, and held as the best treatment alternatives; or it may simply exist in what the marketplace has selected as the favored treatments of choice for a broad range of reasons.

The invention defines benefit and risk through scores. Scores are numeric values created by algorithms that use algebraic and statistical methods across critical factors in the model to value risk and benefit. In some cases these numbers are factored, fractionated or apportioned, sometimes multiplied or even minimized in their effects; all are subtotaled into several categories. Lastly the software consolidates a total number for each, representing benefit and risk as B, r, keeping them as discrete values. (FIG. 33)

Each score represents a degree of benefit or risk intensity with larger scores representing larger effect. Relevance and meaning is given to these scores by their relationship to comparative technologies in the drug, biologic or medical device field that already exist in the marketplace.

For the purpose of this invention, a benefit is defined as a feature, attribute, functionality or utility of a technology that confers advantage to a healthcare payer, prescriber, delivery system or patient. Benefit is highly likely to increase favor or use of that technology among these users. Benefits in the model are given subjective ratings from its users such as “Effective”, “Significantly Effective” or “Breakthrough Technology” (FIG. 34) and objective ratings such as “Relative to ICER Budgetary Boundaries.” (FIG. 35)

Benefits are expressed as numeric scores as described above (e.g., 10 B in FIG. 36) as colors (green equals highly beneficial or Breakthrough Technology, FIG. 37) and by placement on a two-dimensional x-y axis, depicted as a graph (FIGS. 38 and 39) representing a positional score of the technology in question relative to other technologies serving as either direct or theoretical comparators.

Increasing benefit is illustrated on the graph by the movement of an icon further to the right side of the graph depending on its value, using the convention of the lowest “X” or in this case, “B” value as the graph origin. This is similar to standard convention of using “0” as the origin starting value for the “X” axis. Since the “B” values are displayed relative to each other, only if a product has a “0” for its “B” total value, will the graph actually reference to the origin using “0” for the “X” or “B” axis coordinate. Otherwise, it is the lowest “B” value among the product scores that set the low range value boundary for the display of all the products being placed relative to each other. The highest product “B” value then sets the upper “X” axis range value boundary of the field of the graph. Representative icons are assigned to each product being measured.

For the purpose of this invention, a risk is defined as a dangerous, harmful or unwanted feature, or consequence arising from the intended use of, or developmental pathway for the given technology under consideration. Risk confers disadvantage(s) to a healthcare payer, prescriber, healthcare delivery system or patient. Risk is highly likely to decrease favor of that technology adoption or use, and in some cases risk may be so significant as to result in caution, disinterest or complete discontinuation in the use of such technology among one or all of the parties mentioned above. For example, in the case of minimal risk from the perspective of medical safety, a healthcare service provider could see a significant infrastructure expense from the adoption of a new technology that would not warrant its use no matter how beneficial its medical contribution might be.

As in the case of benefits cited above, risk in the model is assigned with subjective or objective ratings from its users. An example of a subjective rating would be the severity of risk as in the case of side effects such as “not serious, fairly serious, and very serious.” (FIG. 40)

An objective rating of the side effect however would be the frequency of the occurrence of that event such as “Infrequent Occurrence” meaning between 0.1% and <1%. (FIG. 41) A subjective rating requires community or stakeholder feedback to qualify seriousness or severity of risk, whereas the objective rating simply defines a metric such as frequency of event. Risks are expressed as numeric scores (e.g., −6 r—see FIG. 42); colors (red equals high risk technology) and through placement on a two-dimensional x-y axis, depicted as a graph (FIGS. 38 and/or 39) representing the total score of the technology in question. Increasing risk is illustrated on the graph by the movement of an icon vertically upwards. Increasing risk is illustrated on the graph by the movement of an icon further up the vertical or left side of the graph depending on its value, using the convention of the lowest “Y” or in this case, “r” value as the graph origin. This is similar to standard convention of using “0” as the origin starting value for the “Y” axis. Since the “r” values are displayed relative to each other, only if a product has a “0” for its “r” total value, will the graph actually reference to the origin using “0” for the “Y” or “r” axis coordinate. Otherwise, it is the lowest “r” value among the product scores that set the low range value boundary for the display of all the products being placed relative to each other. The highest product “r” value then sets the upper “Y” axis range value boundary of the field of the graph.

Together, the coordinates of the “B” and “r” total values then set the positions of the product icons on the field of the graph, each product icon having their positions set by their respective coordinates and relative to each other positionally (FIGS. 38 and/or 39).

Another key element of positioning is described in FIG. 43, and referred to herein as the Z axis. The Z axis creates a third dimension to the two dimensional x-y axis for the purpose of providing additional functionality to the software tool. The rising Z-axis represents a numerical, intensity or size increase in each of the following areas described below:

The Z-axis can be used to describe a population of target users for the product based on a specific qualifier. This qualifier could be a single biomarker or set of biomarkers that define an optimal population for use of the technology, such as a genetic biomarker identifying a diabetic mechanism of action. (FIG. 44)

The qualifier could also define parameters within the clinical trials that limit the use of the drug, biologic or medical device to very specific indications. For example, the product may only be used for Stage 3 non-small cell lung cancer, thus limiting the product to a subpopulation of the total lung cancer disease group. (FIG. 45)

The Z-axis can also be used to describe the extent of market uptake for the product at a particular point in time. Market uptake of new technologies is dependent upon many factors; many of these factors or contributors are reflected in the model. The Z-axis describes the rate of market response to the technology's benefit/risk profile by forecasting how prescribers, payers, healthcare service providers and governments will affirm the utility of the technology by making it available and under what conditions. This availability includes time to formulary access, standards of care, physician adoption rates, patient acceptance, payer requirements for reimbursement, etc. (FIG. 46)

The Z-axis can be used to describe a return on investment for the drug, biologic or medical device based on the product risk benefit profile that is developed. (FIG. 47)

In all the cases 1), 2), 3) and 4) described above—target populations, indications for use, market uptake and return on investment—the graphics display can use a multi-frame function that captures the fourth dimension of time. Time creates the opportunity for a progressive addition of new product users (for example, as more gene or receptor targets for a biologic under development are identified) or as additional clinical evidence supports new product uses or as markets open up to greater access, or as all of the above yield a greater return on investment.

As time progresses an evolving display of additional product uses or target product users or further market penetration of the product displays as a multi-frame function on the current software tool. This functionality—or combinations of the above functions, including cumulative returns on investment are displayed on the x-y-Z axis as a series of frames. (FIG. 48)

In defining drug, biologic or medical device pathways to ensure a successful target product profile, multiple benefit and risk considerations must be made. One important consideration is the significance of a particular benefit or risk, relative to others. This significance is expressed in the invention as a weighting or apportioning function of the software in the following ways:

Any critical factor defining benefit or risk can be apportioned with a more significant emphasis on the scoring of its B or r value relative to other factors in the same category. This is referred to as a weighting of the factors in the model. This disproportionate weighting of certain factors relative to others in the software is accomplished through a function that proportions the total score of the factors in a category to 100% as illustrated in FIG. 49.

The sum of the factors in a category can be apportioned with a more significant emphasis on the scoring of its total B and r value relative to the other categories. This is referred to as a weighting of the categories in the model. The sum of the total B and r score in the model can be apportioned with a more significant emphasis on the ratio of the B score relative to r score. This is referred to as a weighting of the model. This represents a multiplication up or division down of either score to represent an appropriate risk benefit ratio for the therapeutic class in review, as illustrated in FIG. 50.

In determining a target product profile, the key drivers will include the minimum benefit and maximum risk thresholds for success, commercial viability requirements and the capability of the technology to create a marketable value proposition. Products in development must meet these success thresholds in order to present a significant enough gain in innovation to justify the continued investment in both research and future sales and marketing.

In the present invention, these benefits and risks can be graphically charted, scored, then weighted to reflect the proportionate value of clinical trial data, value proposition, marketplace and stakeholder feedback to the overall invention gain. The software can model various what-if research and development scenarios for forecasting in real time for the likely attainment of the target product profile. The tool does not select a single “best path” for optimized research and development from a pre-existing knowledge base of best practices. Instead, since the new technology in question has not yet achieved market status and is therefore not tested or validated in a broad set of patients, it is important to understand that a target product profile can be potentially attained through a combination of any number of possible benefit achievements or risk containments. The effective use of the tool is therefore in accurately forecasting how optimal target benefit risk ratios could be achieved. By doing so, the tool can be used to predict overall success in drug, biologic or medical device research and commercialization, thus facilitating business decisions, including the time taken before go, no-go decisions are made.

Evaluated technology candidates are displayed relative to the benefits and risks for target product profile attainment on both a comprehensive, color-coded and numeric scorecard and a four-quadrant risk/benefit graph. The color coding for the scorecard does not use arbitrary colors, but instead corresponds to the objective of research to go forward if metrics indicate good progress in attaining the target product profile (green scores as in a green traffic light), but show caution to either slow development until improvements are configured (yellow/orange scores as in a yellow traffic light) or stop development if the product cannot sustain an acceptable risk benefit ratio (red scores as in a red traffic light). The scores are displayed numerically within the respective color-coded boxes, or as simple color-coded, donut-shaped icons.

The four-quadrant graph likewise positions the new technology candidate relative to current market and/or theoretical (i.e., “what if”) competitors, thus enabling a clear picture of the risk benefit alternatives of numerous research path options that can be demonstrated in real time. This informs research decision-making by automated icon movement into the red, orange, yellow and green quadrants as potential new investments and development choices are migrated through changes in numeric scores indicating various positions on the risk benefit graph. This allows instantaneous business decision making, assessed using the traffic light color-coding for signaling the advance, slowing or stopping of the research project.

Sometimes these choices can be theoretical; that is certain endpoints may or may not be achievable but can still be anticipated. The tool allows the user to forecast various scenarios in advance of actual accomplishment of the metrics in order to anticipate best and worst case research results and thus plan accordingly. For example—if the primary medical endpoint in the substance use disorder drug trial is abstinence what is needed to be truly differentiated from the competitors if a threshold population that achieves this endpoint is 25% of trial participants? Could changes in other endpoints, like reduction in substance use at 45%, compensate for a less than threshold abstinence amount, say only 20%, to make up for the abstinence endpoint under achievement?

Therefore multiple versions of the software output can be saved for various purposes such as tracking, planning and forecasting resource allocation and return on investment with a great number of these theoretical outputs. These multiple versions of the software output are catalogued in a tab in the tool where they can be referenced for comparative purposes, or stored for future analysis. (FIG. 51)

Additionally the software can print any of the saved copies for use as such.

Color-coding can also be combined with shape coding in the following way to further facilitate comparative analysis: the initial version of the trial results are recorded in donut icons, but in newer versions with the latest research results, upward triangles denote improvement in the metrics relative to the previously recorded outcomes. Likewise downward triangles denote regression in the metrics relative to the previously recorded outcomes. Results which remain in the same positioning remain as donuts. (FIG. 52, FIG. 53.)

The data used in the model can come from many sources: clinical trials, medical literature, electronic medical records, retrospective database analyses, government and private sector documents/data analytics and historical commercialization trends or factors, etc. The model allows for storage of this information behind each individual icon in which an assessment is made. (FIG. 54)

For example, using the HbAlc example of a medical efficacy score for type two diabetes, by clicking on the donut shaped icon for Januvia®, one of the comparator drugs in the class, the reference document will display. This document is the highlighted PDF file of the package insert of Januvia® which references all of the clinical trial results for FDA approval. These trial results are recorded in efficacy terms such as a reduction in HbAlc, like the other comparators for the target product profile. This in turn corresponds to a specific data selection that is taken in the model for benefit or risk to create a score. (FIG. 55)

Since drug, biologic and medical device research takes so many years to complete, the software tool must accommodate a continuous feedback loop of metric creation and validation that scores benefit and risk through an ongoing process of stakeholder input. This information may be input to the model using a variety of screens and/or input as an initial set of predetermined values by a single user or initial team of users/creators.

Validation of initial data frameworks for benefits and risks is achieved by soliciting larger advisory boards of potential technology users. These users could be physicians, patients, payers (including governments) and healthcare service providers such as hospitals, health plans and clinics. Advisory board feedback is displayed in the model and classified in generalist terms that can be interchanged for specific names or left as anonymized contributors. (FIG. 56)

The feedback can also be more specifically tailored for physician advisors, including their specialties. (FIG. 57) The use of inner and outer rings for defining advisory feedback contributors can further characterize advisors for a clearer understanding of who supports the model metrics as written and who does not. It is the intent in soliciting advisory board feedback that the software users gain a specific understanding of to what extent the metrics reflect a community consensus of benefit and risk versus a single user or smaller team's perspective.

In many cases, the model allows for scaling or weighting adjustments made by the user and again validated and further adjusted by stakeholder feedback to reflect evolving innovation priorities from the community at large. These data are used to define and refine the technology benefits/risks, value proposition and predictive market performance in the context of changing medical innovation or marketplace dynamics in addition to the technologies evolving research results from subsequent clinical trial results or that of competitors still in development.

Following the setting of the model to the profile that is approved by the development team to represent the most accurate validation of marketplace realities, the team can then use the metric settings to calculate the likely market price for the product in development based on the pricing of the model comparators. This pricing comparison can be based on daily, monthly, yearly or per treatment course rates, as is deemed appropriate for adequate marketplace comparisons. (FIG. 58)

The model uses an algebraic formula using as critical ingredients: the proprietary designs of this patent for applying weights of the contributory significance of benefit and risk scores of a drug, biologic or medical device in development relative to the benefit and risk scores (B/r) of its marketplace comparators, for which pricing is known. Attainment of these scores by using the model is indicative of a justifiable comparative attainment of a specific price point or price range. The assumption presumes that benefits increase product value and risks decrease product value. The contributory significance of risk and benefit scoring can be adjusted by the relative value of risk versus benefit for any specific therapeutic category, or for any adjustment in scaling of categories or factors within the model before applying the relational pricing versus the B/r score. The logic of building a candidate pricing model is provided below, but is not intended to reflect the logic necessarily always used, but as a guide for a pricing approach. For example, a price elasticity approach would use some components listed here and more components not listed here:

Let:

P1:=price of product #1

B1:=Benefit value for product #1

r1:=risk value for product #1

P2:=price of product #2

B2:=Benefit value for product #2

r2:=risk value for product #2

P1low:=price of lowest priced product

P1high:=price of highest price product

So using a proposed price equation, for two products we have:

P1=alpha*B1−beta*r1 and P2=alpha*B2−beta*r2

This is a system of linear equations. Solving for alpha and beta yields:

alpha=(r1*P2−r2*P1)/(r2*B1−r1*B2)

beta=(P1*B2−B1*P2)/(r1*B2−r2*B1)

Let

Pavg:=average price of competing products

Bavg:=average Benefit value of competing products

ravg:=average risk value of competing products

Plow:=low price of competitor product

Phigh:=high price of competitor product

P=Pavg+alpha*(B−Bavg)−beta*(r−ravg)

alpha=(r1*P2−r2*P1)/(r2*B1−r1*B2)

beta=(P1*B2−B1*P2)/(r1*B2−r2*B1)

Alpha is the scaling factor for benefit where:

r1, r2=final risk scores from referenced 2 competitors

P1, P2=individual prices of existing competitors

B1, B2=final benefit scores from referenced 2 competitors

Beta is the scaling factor for risk where:

r1, r2, r3, r4=final risk scores from all competitors

P1, P2, P3, P4=individual prices of existing competitors

B1, B2, B3, B4=final benefit scores from all competitors

Benefits and Risks

The benefits and risks are first examined from the perspective of the medical efficacy and safety profile. Preferably, these benefits and risks are based on clinical trial data, and in the case of the new technology in question can only come from that source, as the product is not available in the marketplace. The comparative degree of success in achieving clinical trial endpoints is relative to other marketed or emerging technologies in the same therapeutic area with the same indication. An indication is a specific FDA approved use for the product.

In the case of new technologies with no medical comparators, appropriate comparators for different indications with similar endpoints may be used. Therefore the tool shows its utility in decision-making even when alternative product choices do not exist per se. Furthermore, as medical benefits and risks do not have self-evident benefit or risk values inherent within any single metric, the tool translates various levels of metric achievement into categories of success such as “Not Effective”, “Very Effective”, or “Breakthrough Therapy”. This successive categorization of effect allows new innovations to exceed previously attained thresholds of effect (known as the standard of care) as well as allowing its users such as physicians, health plans or payers to assess the value of the new drug, biologic or medical device in research into a benchmarked hierarchy of incremental gain or loss over its predecessors.

Previous to this invention, as only one example, no tool was available in drug, biologic or medical device research to link a specific measure (example—a 2.0% reduction in A1c for diabetic drugs) with a specific user value (working nomenclature) of its importance (i.e., an interpretation of this effect as a “Breakthrough Therapy”) with a specific scoring system (example—135 B score for benefit) with a specific real-time weighting of it relative significance (example—135 B may be adjusted to reflect a fraction or multiple of the significance of a second medical efficacy score, such as a reduction in blood pressure). Thus, in the case of multiple clinical endpoints, the tool is capable of simultaneously scaling the relative importance of different research targets to each other in addition to scaling the relative importance of the degree of effect within individual metrics being evaluated.

Side effects are evaluated as risks which arise out of these trials and which express a risk score of certain frequency and severity that impact the feasibility of the innovation to meet regulatory approval and achieve marketplace success. The software uniquely scores the overall significance of risk by multiplying the severity of side effects by their frequency of occurrence. This rule recognizes that risk entails more than a single component for more accurate predictive modeling for drugs, biologics or medical devices to forecast likelihood of risk containment in post-trial populations. As in the case of benefits, the significance of a result with an individual side effect and the relative importance of one side effect versus another can be also scaled within the model.

Value Proposition

The medical benefits and risks are viewed from the perspective of a multi-stakeholder or technology user community. These stakeholders can include physicians, payers, health plans, patients and drug, biologic or medical device developers. Community values are generated when medical efficacy and safety is translated and/or framed into concepts that are meaningful to specific users. These concepts can include cost effectiveness for payers, quality metrics for healthcare delivery systems and patient reported outcomes for patients. When these concepts are joined together with the product's medical efficacy and safety values, these metrics offer a consolidated score to point towards the likelihood of commercialization success at the end of the research and development process. Ideally, this score represents a consensus of the total value proposition of the technology for the entire community of drug, biologic or medical device users. The contribution of each particular stakeholder's needs for specific definitions of value is proportionately weighted and integrated into the total value proposition of the technology's attributes and drawbacks, i.e. benefits and risks.

The range of possible stakeholder benefits and risks that can be translated from the medical efficacy and safety profile are broad as it relates to the user community, yet specific to the therapeutic area under evaluation. These comprise the value proposition of the invention. Each therapeutic area defines benefit and risk in different terms as diseases impact patients differently in terms of their severity, prevalence, treatment options and the benefit risk ratio of these current options. Research and development demands a realistic assessment of all of these factors, which the software addresses. The community impacted by the drug, biologic or medical device will play a critical role in the translation of benefit and risk in the tool into the value proposition as outlined with examples below:

Patients—Outcomes of therapy that impact physical, mental, emotional, and social functioning can be measured, weighted, and integrated.

Health Care Systems—Measures of quality and efficiency that improve value to those health care delivery systems involved in the delivery of care can be entered. These include institutions such as acute care (hospitals) and long term care (nursing home) facilities, as well as specialized care centers (oncology, pain, diabetes centers of excellence), community-based clinics and integrated care delivery networks.

Payers (Employers/Governments)—Improving cost effectiveness and targeting patient populations to lower spending and increase value that will enhance employee or beneficiary productivity and improve health outcomes. Payers can also refer to the innovation developer, who, by applying certain strategies (e.g., utilizing biomarkers), will improve the efficacy for targeted subpopulations in research and therefore increase the likelihood of both development and marketplace success, resulting in a higher return on the research investment.

As in the case of the medical efficacy and safety factors above, the software tool allows for the individual and relative scaling of value proposition measures against each other. Furthermore, in the development of the value proposition during the research process, one other element is vitally important in creating an optimal risk/benefit profile. The tool mitigates risks through a function that allows for the subtraction of excessive side effect severity and/or frequency through marketplace and stakeholder interventions designed to ensure appropriate use of the product or control of product misuse or abuse.

These risk mitigators are scored commensurate with their value and capabilities to manage side effect risks, and can be adjusted up or down accordingly. They can include a number of established market-accepted interventions to control risk such as patient registries, lab tests, physician certification, controlled distribution, and patient and provider education. While these interventions do not decrease the absolute risk of side effects the relative risk of these side effects can be mitigated in one of several ways:

Using registries enables providers to identify specific untoward effects earlier and to allow for more specific monitoring for such. Registry processes can institute immediate shut down of continued product use.

Controlling distribution to certified or educated caregivers can ensure that drug, biologic or medical device prescribers are adequately educated on the potential side effects of new technologies so that they might look for and respond more immediately to problems as they are presented.

Educating patients with increased awareness of the risk benefit ratio of the interventions that have been prescribed to them enables their vigilance and empowerment in ensuring successful outcomes in product use.

During the research and development process, as potential challenges with side effects arise, effective planning with risk mitigation tools in mind, implies some of these can be built into the later stage trials for testing and validation. Like many of the other value proposition factors listed above, testing the use of these potential pathways for research and development success can mean the difference between an adequate or inadequate risk benefit ratio in meeting the target product profile.

Marketplace Success Prediction Factors

The third set of values comes from the application of the tool in evaluating the likelihood of marketplace success. This third set of commercialization factors are success predictors of the drug, biologic or medical device application in the marketplace and can be described by some of the following examples:

Ease of use—generally product formulation or presentation variables across a broad range of parameters from administration, to temperature, storage and transport requirements to delivery to packaging.

Patient access—payment contribution based on payer demands and access restrictions.

Provider restrictions—healthcare deliverer (physician, nurse, care system) or system constraints due to payment, access, regulatory hoops or other considerations such as government coding or reimbursement requirements.

Marketplace considerations—historical trends of the market, including past requirements for access and entry into selected markets based on competitor success or failure for access.

Data from the three categories outlined above—drug, biologic or medical device medical benefits and safety risks, the value proposition and the marketplace success predictors—can be relatively scaled against each other to present the most sophisticated assessment of the drug, biologic or medical device's total benefit and risk profile. Furthermore, the relative degree or market tolerance of risk versus benefit can also be assessed in the therapeutic category using the model-scaling feature. As referenced above, each therapeutic area can be scaled to present a unique benefit risk ratio. Likewise, in each therapeutic area, the relative importance of each of the three categories can be unique to a therapeutic area. For example, in skin care, research and development will strive for a low tolerance to risk at the expense of a high tolerance to minimal benefit. Not so in cancer, which presents the exact opposite scenario. Again, in cosmetic skin care the marketplace success predictors and value proposition components will weigh more heavily in the total valuing of the drug, biologic or medical device benefits than the medical efficacy component. Therefore the software might apportion marketplace 3 to value proposition 3 to medical efficacy 1 in the weighting function. However, for cancer indications the same functions might weight 2 marketplace to 1 value proposition to 3 medical efficacy.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

FIG. 1 illustrates an exemplary system useful for evaluating and comparing medical treatments, according to an embodiment of the present invention.

FIG. 2 illustrates an exemplary method for evaluating and comparing medical treatments, according to an embodiment of the present invention.

FIG. 3 illustrates a schematic including exemplary model elements of the present invention.

FIGS. 4-30 are exemplary layouts for various screens useable to input information and output a scorecard and other summary information.

FIGS. 31-32 show an exemplary comprehensive scorecard including several medical treatments being compared relative to the benefits and risks for success.

FIG. 32 shows an exemplary four-quadrant risk/benefit graph.

FIG. 33 illustrates example benefit and risk values.

FIG. 34 illustrates example benefits of a model.

FIG. 35 illustrates example objective ratings.

FIG. 36 illustrates example numerical scores for benefits.

FIG. 37 illustrates an icon representing a numeric score.

FIGS. 38-39 illustrate a two-dimensional x-y axis indicating relative risk and relative benefit.

FIG. 40 illustrates an example of a subjective rating.

FIG. 41 illustrates an example of an objective rating.

FIG. 42 illustrates example numerical scores for risks.

FIG. 43 illustrates an example three-dimensional plot, wherein the Z-axis represents a numerical.

FIG. 44 illustrates an example wherein the Z-axis is used to describe a population of target users for the product based on a specific qualifier.

FIG. 45 illustrates an example three-dimensional plot for defined parameters.

FIG. 46 illustrates an example of an axis for describing the extent of market uptake for the product at a time.

FIG. 47 illustrates an example of an axis for describing a return on investment.

FIG. 48 illustrates an example representation of cumulative returns on investment.

FIG. 49 illustrates an example weighting of certain factors relative to others.

FIG. 50 illustrates an example apportionment of scores.

FIG. 51 illustrates an example interface for interacting with multiple versions of the software output.

FIGS. 52-53 illustrate examples of comparative analysis.

FIG. 54 illustrates an example user interface for assessments.

FIG. 55 illustrates an example illustrating medical efficacy results.

FIGS. 56-57 illustrate graphical illustrations of results displays.

FIG. 58 illustrates an example risk benefit and price per dose result.

### DETAILED DESCRIPTION

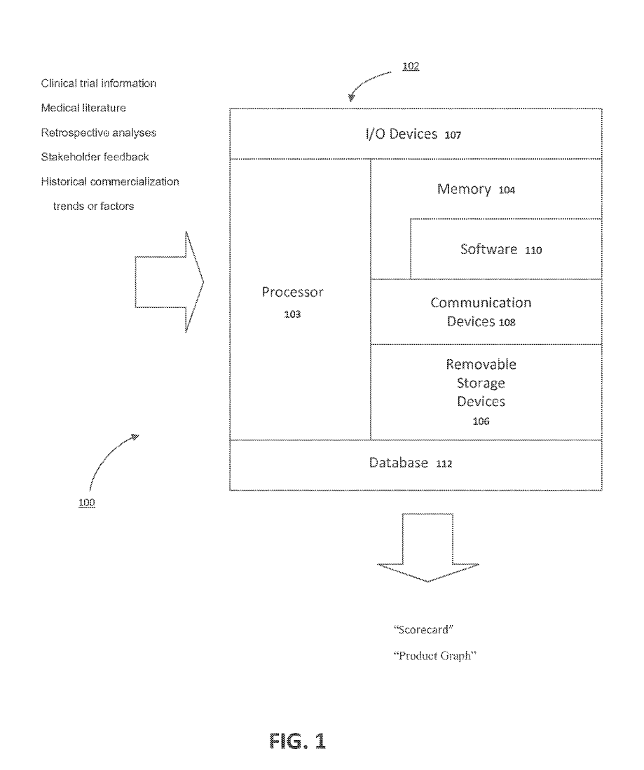

FIG. 1 shows an exemplary system 100 useful for evaluating and comparing medical treatments, according to an embodiment of the present invention. As illustrated the system 100 includes a computer 102 having a processor 103, memory 104 (RAM, ROM, etc.), fixed and removable code storage devices 106 (hard drive, floppy drive, CD, DVD, memory stick, etc.), input/output devices 107 (keyboards, display monitors, pointing devices, printers, etc.), and communication devices 108 (Ethernet cards, WiFi cards, modems, etc.). Typical requirements for the computer 102 include at least one server with at least an INTEL PENTIUM III processor; at least 1 GB RAM; 50 MB available disc space; and a suitable operating system installed, such as LINUX, or WINDOWS 2000, XP, Vista, 7, 8 by Microsoft Corporation. Representative hardware that may be used in conjunction with the software of the present invention includes the POWER EDGE line of servers by Dell, Inc. and the SYSTEM X enterprise servers by IBM, Inc. Software 110 to accomplish the methods described below may be initially stored on a non-transitory computer-readable medium (e.g., a compact disc) readable using one of the fixed and removable code storage devices 106 or transmitted as an information signal, such as for download. The software 110 is then loaded into the memory 104 for execution by the processor 103. A database 112 used to store information can include any computer data storage system, but, preferably, is a relational database organized into logically-related records. Preferably, the database 112 includes a Database Management System (DBMS) useful for management of the data stored within the database 112. Representative DBMS that may be used by the present invention include Oracle Database by Oracle Corp., DB2 by IBM, and the SQL Server by Microsoft. The database 112 can either be a centralized or a distributed database. Alternatively, the database 112 can include an organized collection of files (e.g., in a folder).

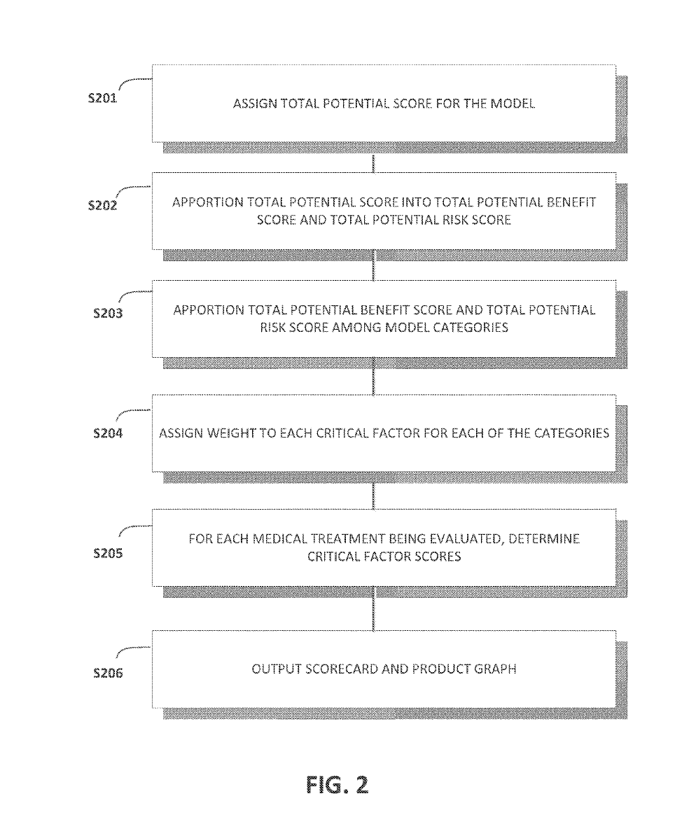

FIG. 2 shows an exemplary computer-implemented method 200 for evaluating and comparing medical treatments, according to an embodiment of the present invention. In a preferred embodiment of the present invention, the present invention comprises the computer system 100 including the memory 104 that stores one or more code segments (i.e., a computer program) including the software 110 of the invention executable by the computer 102. When executed on the computer 102, the present invention essentially transforms the computer 102 into a software tool that can perform the method 200.

It is to be understood that the method steps illustrated herein can be performed by executing computer program code written in a variety of suitable programming languages, such as C, C++, C#, Visual Basic, and Java. It is also to be understood that the software of the invention will preferably further include various Web-based applications written in HTML, PHP, Javascript and accessible using a suitable browser (e.g., Internet Explorer, Mozilla Firefox, Google Chrome, Opera).

Referring to FIG. 2, initially, in step S201, a total potential score 205 is assigned for the model. By way of an example, we have chosen the total potential score 205 to be “300”; however, another value could have been chosen.

In step S202, the total potential score 205 is apportioned, according to a first predetermined ratio 206, into a total potential benefit score 207 and a total potential risk score 208. The first predetermined ratio 206 is a benefit/risk ratio assigned to the model. It can be assigned as a preset value or by allowing the user to input the value (or for the user to override the preset value). In the example, given a 2:1 benefit/risk ratio, the total potential score 205 (“300”) would be apportioned into a total potential benefit score 207 of “200B” and a total potential risk score 208 of “100r”. (Here, the suffix “B” refers to “Benefit” and the suffix “r” refers to “risk”).

In Step S203, the total potential benefit score 207 is apportioned, according to a second predetermined ratio 209, among each of a plurality of predetermined categories 210 to arrive at a total potential benefit category score 211 for each of the predetermined categories 210. Additionally, the total potential risk score 208 is apportioned, according to a third predetermined ratio 212, among each of a plurality of predetermined categories 210 to arrive at a total potential risk category score 213 for each of the predetermined categories 210. E.g., given a 5:3:2 ratio for the categories 210 “Medical Efficacy & Safety”, “Value Proposition”, and “Reimbursement & Administration”, the scores would be: “100B, 50r” (Medical Efficacy & Safety), “60B, 30r” (Value Proposition), “40B, 20r” (Reimbursement & Administration). The second predetermined ratio 209 and the third predetermined ratio 212 can be assigned as preset values or by allowing the user to input the values (or for the user to override the preset values).

In Step S204, for each of the predetermined categories 210, a plurality of critical factors 214 associated with each of the categories 210 are assigned a risk/benefit classification 215 and a critical factor weighting 216. The critical factor weighting 216 can be assigned as a preset value or by allowing the user to input the value (or for the user to override the preset value).

In Step S205, for each of a plurality of medical treatments 217, a critical factor score 218 for each of the predetermined critical factors 214 is determined, the critical factor score 218 calculated using an input value (e.g., entered by a user via a screen) or a preset value, and if the critical factor 214 is classified as a benefit, the total potential benefit score for the category associated with the critical factor weighted by the critical factor weighting; or, if the critical factor is classified as a risk, the total potential risk score for the category associated with the critical factor weighted by the critical factor weighting. Information used to arrive at the critical factor score 218 can come from a variety of sources, including, clinical trial information, medical literature, retrospective analysis, stakeholder feedback, and historical commercialization trends/factors, etc.

In Step S206, a “scorecard” 219 is outputted. The scorecard 219 can include a row for each of the medical treatments 214, each of the rows including one of an indicia (e.g., a color code) and a numeric value for each of the critical factor score 218, for each of the categories. Additionally, a product graph can be outputted showing a total benefit score 220 and a total risk score 221 for each of the medical treatments 214 plotted thereon.

It is to be understood that the preceding description is meant to be illustrative, not limiting. Furthermore, it is to be appreciated that certain of the steps outlined above can be performed in an order different from the illustrated method. For example, the step S204 could be done prior to S203.

Part I: Model Schematic

In the following discussion, exemplary screen shots of the software tool are provided to illustrate its functionality. However, it is to be understood that the examples provided herein are not meant to be limiting. By way of example only, and as described herein, the software has been populated with data for three therapeutic drugs for substance use disorder (e.g., addiction to cocaine). TA-CD is a new drug with no competitor on the market in its class. As discussed earlier, in the case of new technologies with no medical comparators, appropriate surrogate comparators for different indications with comparable endpoints may be used. In this example, TA-CD is compared to SUBOXONE (registered trademark of Reckitt Benckiser Healthcare (UK) Limited) and VIVITROL (registered trademark of Alkermes, Inc.). This illustrates how the software tool can be used to predict the value proposition for first in class entries into the marketplace. It is to be understood, however, that various other drugs/treatments could be evaluated for a variety of different diseases/disorders, and that the present invention has general applicability to various treatment comparisons.

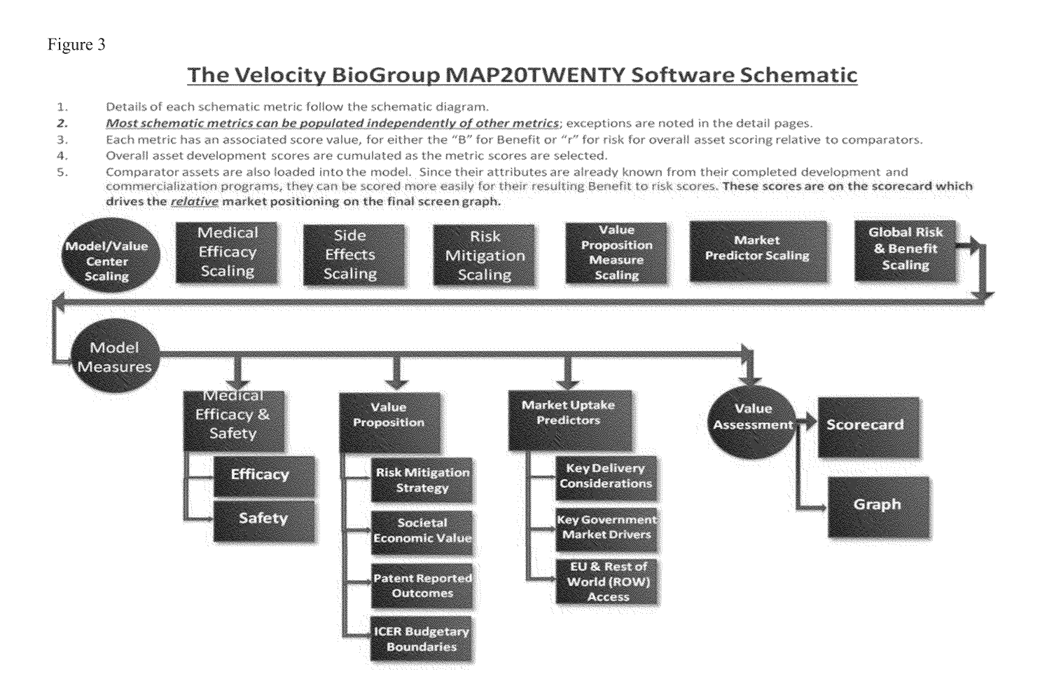

Details of each schematic element follow the schematic diagram shown in FIG. 3. The following points are worth emphasizing (1) most schematic elements can be populated independently of other elements; (2) each element has an associated score value, for either the “B” benefit or “r” risk for overall asset scoring relative to comparators; (3) overall asset development scores can be accumulated as the elements are completed; (4) comparator assets are also loaded into the model. These scores are on the “scorecard” that drives the relative market positioning on the final screen graph.

Part II: Model Scalings

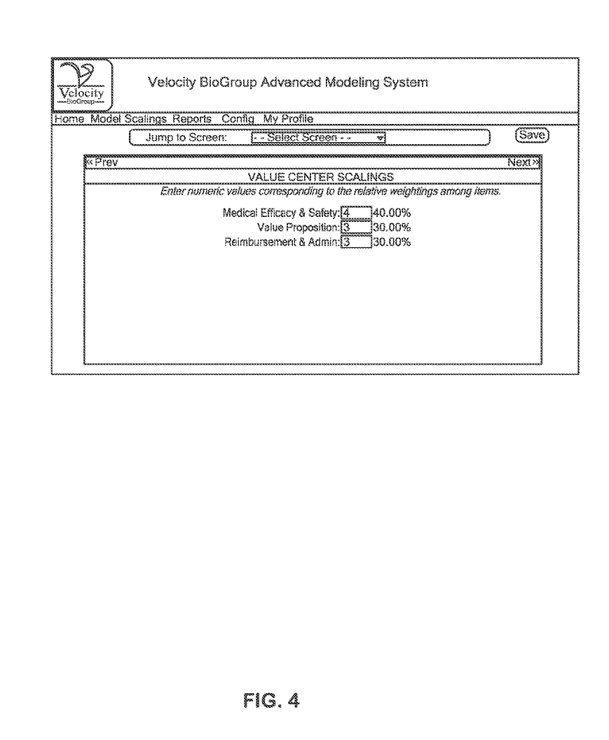

The purpose of the scaling screens shown in FIG. 4 to FIG. 10 is to weight the importance of measures used in the model relative to each other. In some instances, the values entered will override preset values. It is to be understood that the assigned scalings reflect user judgments and users of the software tool could obtain profoundly different results (e.g., scorecards) depending on how the scalings are initially established. However the benchmark products, that is, those operating in the marketplace today, have achieved or not achieved commercial success. These should naturally fall into the quadrants reflecting their overall success in meeting research, value and marketplace metrics. However, unlike software models in which determining benefit and risk is derived from a static set of standards such as found in a compendium like the Physicians Desk Reference or the NCCN Drugs and Biologics Compendium measuring established drugs, this software tool recognizes the dynamic nature of the benefits and risks that can be derived from its clinical trial, value and marketplace metrics. Since medical product development can take anywhere from ten to twenty years, most of the endpoints could become dated or even obsolete from the start of the clinical trial to its marketplace entry. Therefore the tool benchmarks evolving data points—from evolving clinical trials and changes in value definition to changing marketplace standards. This is accomplished by focusing on benefit and risk as a ratio supported by dynamically weighted contributors, not by using a design tree process of laying out premises and arriving at conclusions for best choices from standardized data banks

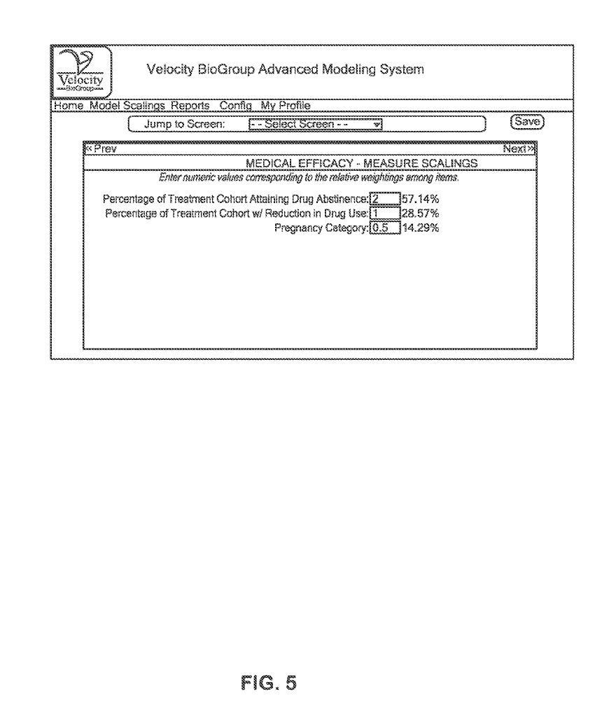

Value Center Scaling (FIG. 5)

The Value Centers describe the three jurisdictional areas that encompass the core attributes of a drug, vaccine, or medical device:

Benefits and Risks—Medical efficacy and safety are defined by results from clinical trials or information derived from retrospective reviews of data from drugs, biologics or medical devices in the marketplace. These measures are described in greater detail elsewhere.

Value Proposition—To what extent can the asset be developed to meet the specific needs of payers, health care service delivery providers, (such as hospitals, health plans, long term care, insurers), patients, caregivers, and governments? These opportunities to translate medical efficacy into stakeholder-specific values, or mitigate safety concerns for similar stakeholder intent, are all configured into the value proposition of the new technology, as it can be developed in order to achieve the target product profile for optimized future acceptance in the marketplace. These translations can include regional, national, and global requirements for value presentation that may in turn affect reimbursement and access in each jurisdiction.

Marketplace Success Predictors—Reimbursement, administration, and access define marketplace success predictors that may pose opportunities or challenges for payment to inventing companies, prescribers and patients. The data captured identifies how public and private payers will affect the future of the drug, biologic or medical device access following its research and development journey through the reimbursement systems, including coding, formulary tiers, prior authorization, co-pays or co-insurance, step edits, and guideline/use protocols. The model is constructed to adjust for both US and global inputs.

In the case of the substance use disorder compounds compared in the example model described herein, it was determined that medical efficacy was a higher predictor for commercialization success than both the development of a value proposition and the reimbursement, administration and access factors (leading to a 4:3:3 ratio.)

Medical Efficacy Scaling (FIG. 5)

The scaling screen for medical efficacy acknowledges that not all efficacy measures are considered equal to health care service providers. Although the Food and Drug Administration (FDA) may traditionally require only one clinical endpoint to measure efficacy, the market may simultaneously value more than one. Additionally, if the science is leading to the emergence of new endpoints to measure efficacy, these new measures may have arising but less established or validated value. One good example is illustrated above in the model in the comparative weight of the abstinence endpoint versus the reduction in use endpoint. Traditionally, abstinence was a singular measure of medical efficacy for substance use trials; today the FDA, health care providers, and payers are beginning to realize the medical benefits of the impact of reducing drug use on overall health outcomes. Some of these outcomes include: reduction in HIV/AIDS transmission, the spread of Hepatitis C, and emergency room visits. Although abstinence is the ultimately desired goal, reduction in use has recently been recognized as a significant and important efficacy measure (thus the 2:1 ratio, as shown). Additionally, the FDA Pregnancy Category classification for the technology is included as part of the values weighted in either the medical efficacy or safety screens. Although it is not a clinical measure, results in the Pregnancy Category can profoundly affect use on specific populations, (i.e., those of childbearing age), which may be very important to the product's success or failure in the marketplace. Category A or B ratings may positively impact the medical efficacy profile in the marketplace, while Categories C, D or X may be viewed as serious side effects and have a significant impact on commercialization.

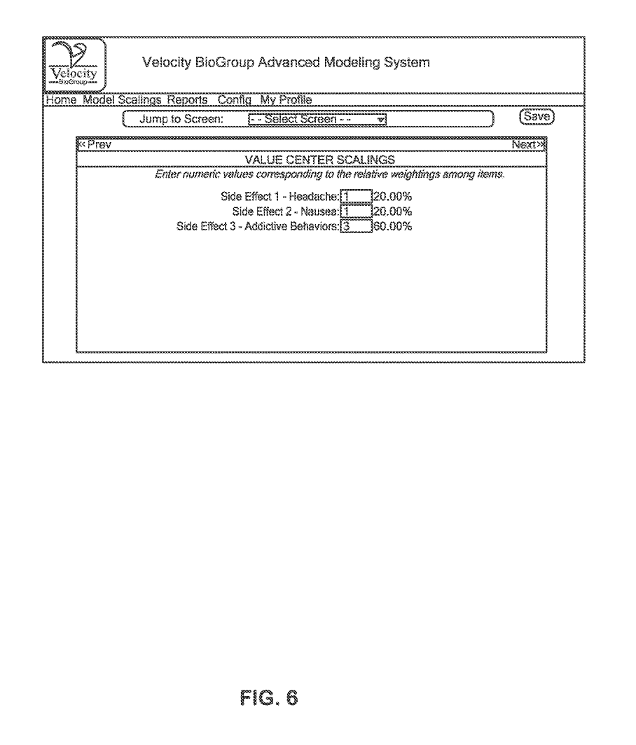

Side Effect Scaling (FIG. 6)

Not all side effects are created equal, even adjusting for frequency and safety variability. Depending on the therapeutic category, and especially the competition of other therapeutic agents within the class, side effects are critical determinants of a product's risk/benefit ratio and its likelihood of commercialization success. The scaling property of the software tool gives the user the ability to adjust for the prioritization of these side effects specific to the demands of the therapeutic category. In order to recognize the impact of these side effects on patients, health care providers, payers, and the FDA's perception of drug approvability, the comparative value of the new intervention relative to older treatment alternatives must be considered. Furthermore, some side effects may be interwoven with the intervention. For example, in the case above, TA-CD has a relatively high frequency of headaches, but withdrawal from cocaine is also similarly associated with a high headache frequency. Therefore its significance as a side effect is less important.

The side effect defined as addictive behaviors comprises not a single measure, but a constellation of measures. This illustrates how the software can capture the complexities of a therapeutic category and the challenges associated with it. In the case of addictive behaviors, addicts can become permanently addicted to their medicines or sell their medications on the black-market. This has resulted in a well-known and very troublesome side effect consequence, and hence a priority to the health care community, as represented by the software scaling (1:1:3 ratio).

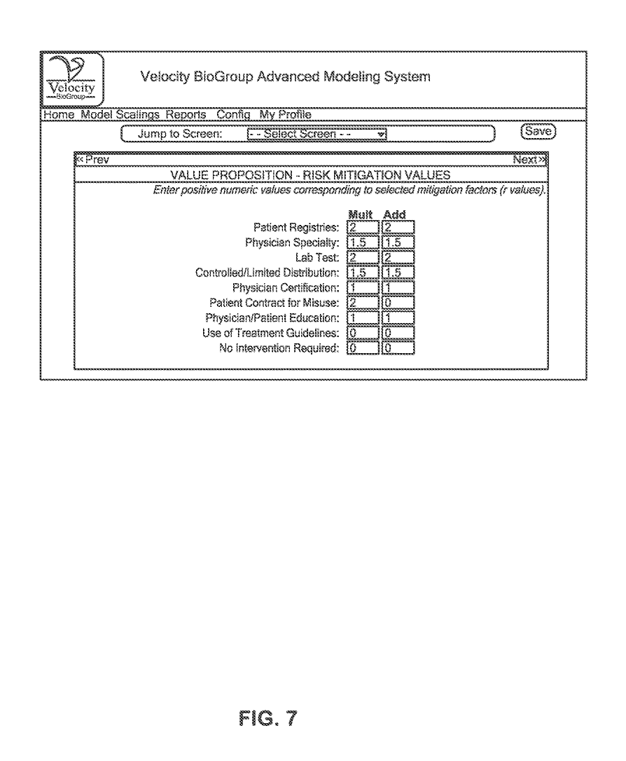

Risk Mitigation Scaling (FIG. 7)

The Risk Mitigation scaling screen is intended to address two components of the mitigation of side effects: actions that reduce the severity of the risk and actions that create a positive or negative commercial impact.

First, mitigations can directly reduce the severity and frequency of side effects, though the model makes these adjustments to the total risk score by subtracting from the severity multiplier. This is depicted here under “Mult” (for multiplier) whose values can be adjusted through a series of additive risk mitigation actions. The values for the set of actions taken are subtracted in total from a single side effect severity multiplier. (This total cannot exceed a designated amount.) It is important for these adjustments to remain consistent across all comparators in the model, including the proposed new innovation. These scores should determine on a case-by-case basis what the likely impact of the proposed risk mitigation intervention would be on the side effect in question.

For example, with respect to substance use disorder drugs, patient contracts for misuse are an important way to “pledge” patients for appropriate use and to help prevent drug diversion, overdose, and/or misuse. These contracts are far more effective, however, if they are also accompanied by an intensive patient education program, which is also a risk mitigation strategy. In the case of the new innovation, TA-CD, patients on the new therapy have been shown to ingest more than the normal dose of cocaine in order to try to override the vaccine's effect. Again, to protect against the potential for the TA-CD side effects, it is necessary to educate the patients in advance of therapy initiation about how the vaccine works and why they must commit to the therapy with a contractual understanding that there is “no going back on their therapy commitment.”

Secondarily, in the right column called “Add,” the software adjusts for the commercial impact of the proposed risk mitigation strategies on market access and reimbursement. For example, patient registries can positively control misuse and mitigate potential adverse reactions; however, many physicians will not write prescriptions for technologies that they must manage through a registry because of the concomitant time and paperwork demands. In this case, the subtraction from the multiplier (by use of a patient registry) that reduces side effect risk and therefore lowers risk score can also be adjusted as an addition or subtraction to the risk score using the right hand scaling column to account for the potential negative or positive impact to commercialization.

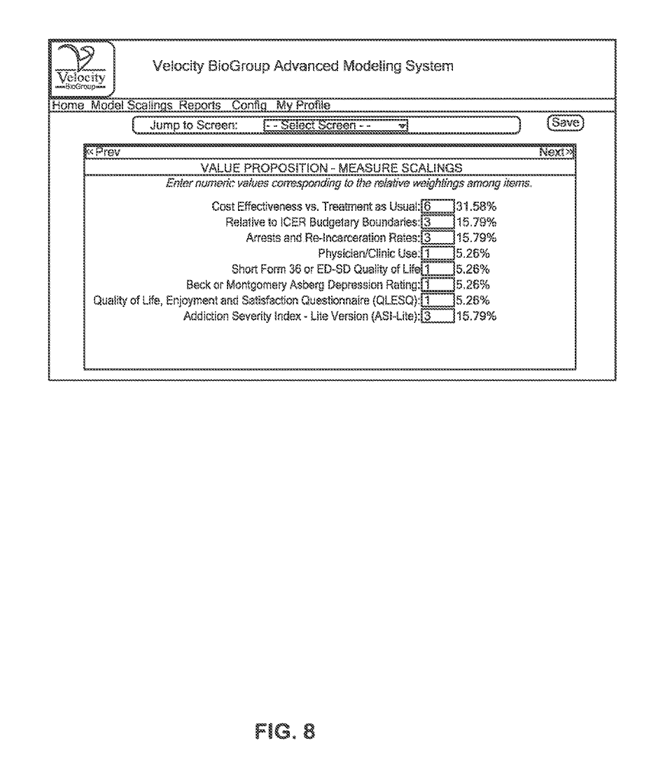

Value Proposition Measure Scaling (FIG. 8)

This scaling screen weights the spectrum of value proposition factors that can translate the medical efficacy and safety factors of the software into viable value proposition components for payers, health care systems, and patients. This “translation” involves the development of specific tools and secondary clinical trial endpoints that will paint a comparative picture of the asset's capabilities to deliver this specific value proposition relative to that of the competitors under consideration.

In the case of the model presented above, the components of the translation include those elements of the new technology that present an economic value proposition to payers, particularly in terms of the current standard of care. Since drug abuse is a costly societal problem, the scaling weights are adjusted to reflect these economic impacts. Additionally the software tool recognizes international development: these assets use the Incremental Cost Effectiveness Ratio (ICER) for evaluations in Europe through the National Institute for Clinical Effectiveness (NICE) by considering their budgetary boundaries for product reimbursement and access. In the example presented here, arrests, re-incarceration, and physician clinic use are all substance use disorder markers for creating secondary endpoints for the disproportionately high numbers of cocaine addiction sufferers who enter the criminal justice system and require treatment.

Finally, the last four components of the scaling chart are measures of patient-reported outcomes that are used as secondary endpoints to assess the impact of the treatment intervention on the wellbeing and quality of the patient's life.

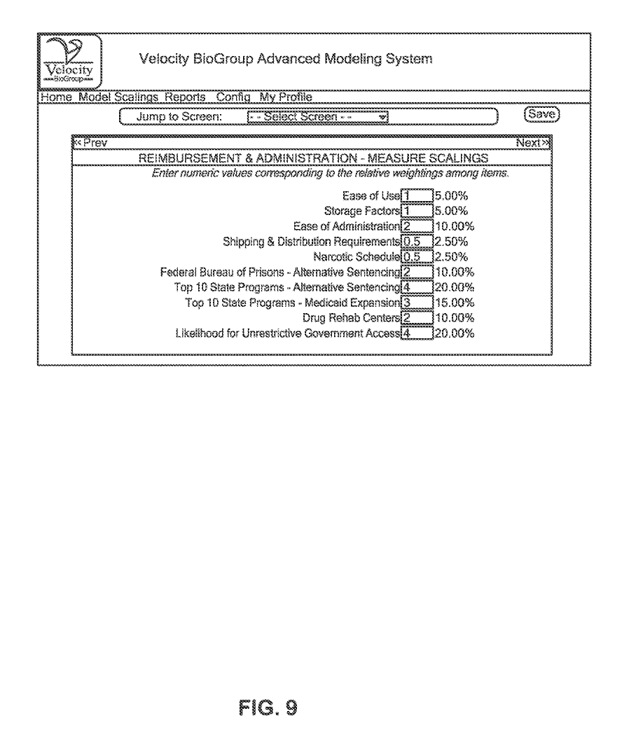

Reimbursement and Administration Scaling (FIG. 9)

Market dynamics include a wide array of factors that impact the commercial success of a new technology. It must include the perspectives of the patient, clinician, and payer. The patients and providers determine the proper scaling for use and administration. Oral formulations are generally preferred over injectable formulations for the patient. For the provider, route of administration can impact reimbursement from payers and plays a significant role in determining product choice. Scaling for the payer is focused on cost savings from a “systems” perspective in the private market and the societal costs in a public market. These marketplace success predictors are critical to the overall assessment of the value proposition for the new technology.

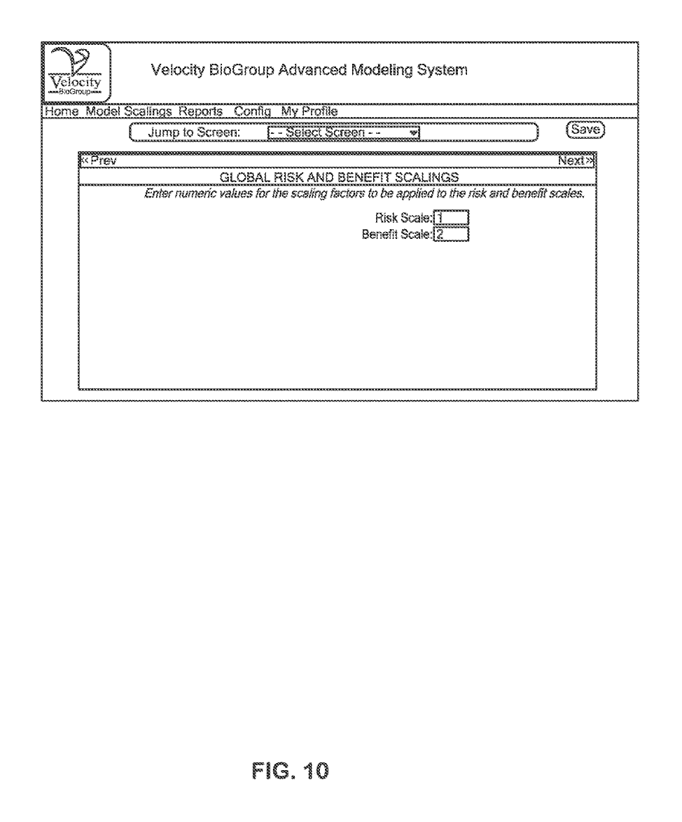

Global Risk & Benefit Scaling (FIG. 10)

The global risk and benefit scaling is the highest-level assessment in the model. It is here that the user determines the relative weighting of risk and benefit for the therapeutic category of the asset under consideration. This ratio between the risk and benefit is again very specific to a therapeutic category in question; for the products in this example for substance use disorder, the relative benefit risk ratio is 2 to 1 based on the lack of effective treatment interventions in the marketplace. The ratio recognizes not only the limited biopharmaceutical competition in existence today but also the limitations of the alternative treatments currently in use, including the enormous medical, personal, and societal costs associated with less-than-optimal treatments. Following application of the risk and benefit scaling the scores in the three categories of medical efficacy/safety, value proposition and marketplace success predictors are then set at a standardized score. These standardized scores are therapeutic and indication specific to the tool; values are normalized to keep the results consistent no matter what weighting and apportionment of the critical factors and categories is applied. Therefore the tool presents standard scores per therapeutic category.

Part III: Critical Factors

Medical Efficacy & Safety

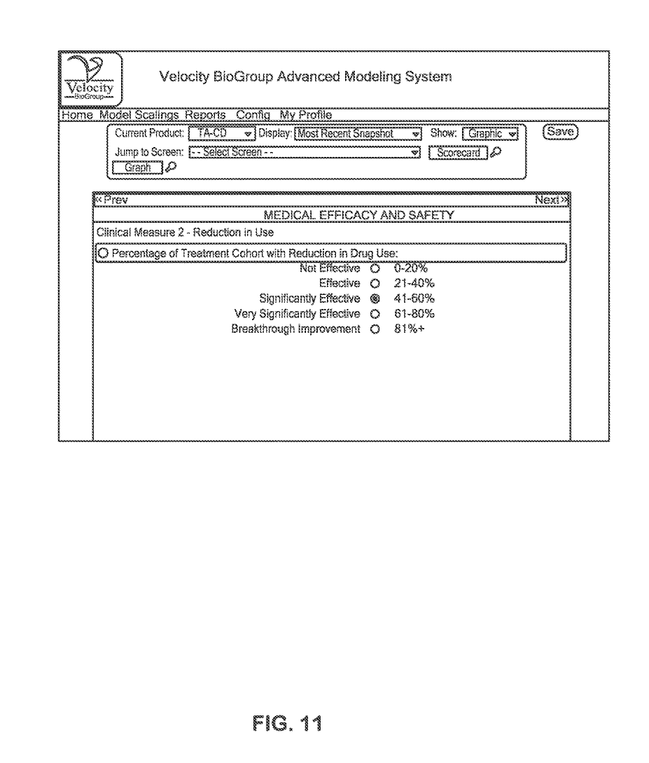

A. Efficacy (FIG. 11)

The clinical efficacy measures are measures or metrics of how a drug, biologic or medical device in research and develop should perform in order to be efficacious or capable of producing the intended effects. In the software tool these measures are assigned levels of significance to specific FDA-required or proposed primary endpoints. In the example of the substance use disorder vaccine above (TA-CD), “reduction in use” is one such efficacy measure common to the research process. Here, the model presents comparisons of efficacy values achieved by the target drug (or vaccine) in the clinical development program against two comparators currently in use in the marketplace. (See top of screen for pull-down menu item “Current product” tab in the floating blue box. This is used to alternate between the comparator drugs, in this case Suboxone® and Vivitrol®, loaded as comparators.) In the example above, the percentages refer to the percentage-of-substance-use reduction for the substance of abuse in question as defined by the clinical trial parameters. Multiple screens can be created to capture all efficacy measures related to the therapeutic class under review.

The levels of significance are unique to the therapeutic area and are established by the stakeholder community's assessment. Generally for medical measures, the body of relevant physicians will determine the significance of achieved clinical trial results; however, any relevant stakeholder in the healthcare value chain can assign value to these trial efficacy measures. Each level of significance has a specific benefit score assigned to it that then becomes a component of the total cumulative score of total benefit in the model scorecard.

B. Safety

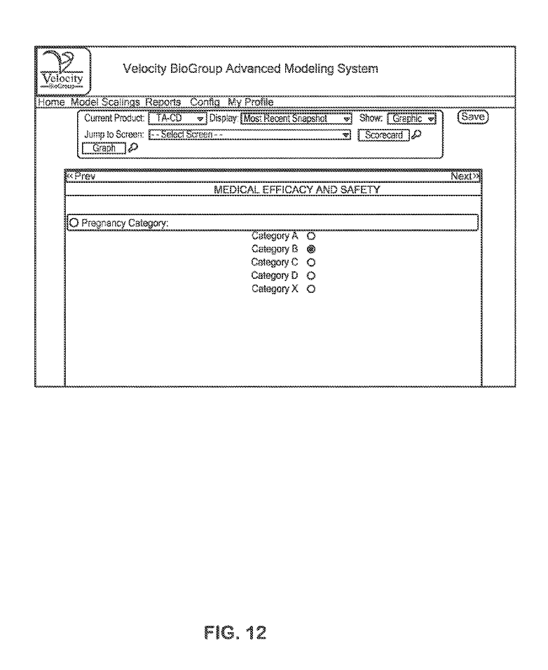

Pregnancy (FIG. 12)

The FDA Pregnancy Category classification rates the relative safety of new drugs, biologics or medical devices on unborn children that reflects the perceived risks of use of a product on women of childbearing age. These designations can have a significant effect on usage depending on the therapeutic category in question. Some of the categories, (such as Category X) are so onerous as to create the need for extensive risk mitigation plans. In the case of the example product above, TA-CD is forecast to be relatively benign in pregnant women (Category B) relative to the Category C rating of its comparators, meaning that the TA-CD has not demonstrated untoward effects on the unborn in animal clinical trial models. This could be particularly relevant for drug addicts who are often young women.

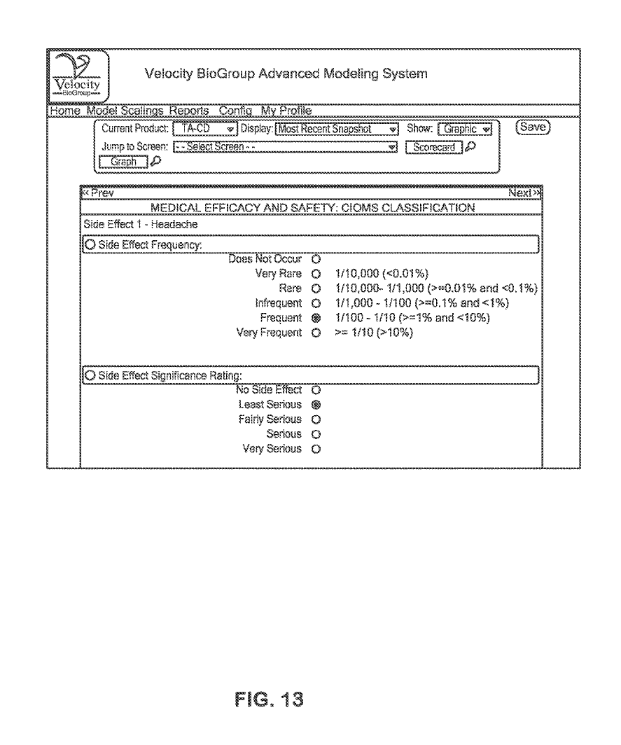

CIOMS Classification (FIG. 13)

This safety screen of the model reflects two components of a risk score, with both components expressed in terms defined by the Council of International Organizations of Medical Sciences (CIOMS), Workgroup IV in 1998. This international body set standardized definitions for frequency and severity of side effects, that are now commonly used in clinical trials by the biopharmaceutical industry and are used in this example herein. The frequency component of the safety measures are multiplied by the severity component to yield a total risk score. Although frequency rates for occurrence are quantitative measures across all diseases states, severity ratings are qualitative in nature. In other words, depending on the specific disease state and comparator medicines in use, the tolerance for a particular side effect varies from product to product and must therefore have a significance rating relevant to the specific stakeholder community. This usually includes the physician community, but payers, health care systems, and patients can all play a role in this evaluation. In the case of TA-CD, headaches often accompany withdrawal from drugs of abuse, and hence this side effect is considered to be frequent. Additionally, the effect is not viewed as particularly consequential within the context of the addiction being treated; i.e., the risk/benefit ratio warrants the product usage.

Value Proposition

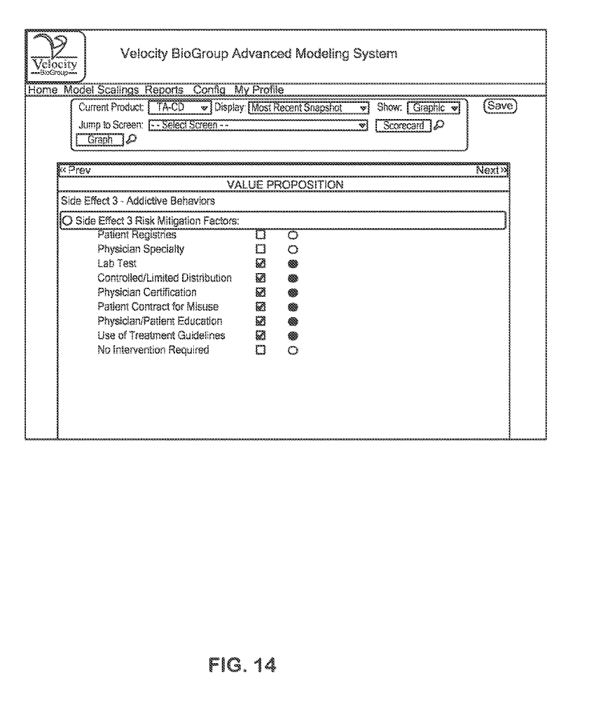

A. Risk Mitigation Strategy (FIG. 14)

Risk mitigation strategies have become increasingly important in the management of the risk/benefit ratio of emerging health care interventions. Companies that do not actively plan these strategies for their new technologies face both marketplace and regulatory approval peril. Within the current environmental context, both the FDA and payers now view risk over benefit as the tipping point in health technology assessment. The software model presents the principal risk mitigation options available. By choosing specific interventions, the frequency and severity of side effects can be reduced and integrated into the overall value proposition for the product. The impact of the risk mitigation intervention on the risk score is adjusted by subtracting the intervention values from the multiplier values of the severity scores of the related side effects. This action lowers total risk by assuming that the intervention will lower side effect severity; in reality, the risk may be lowered by a decrease in the frequency of side effect occurrence as well.

In this example, particular interventions have been chosen to offset the specific side effects of TA-CD. All of the presented strategies have the potential to offset the addict's tendency to try to overcome the product's capability to block the reward effects of the drug of abuse. The goal is to create an optimized approach to risk reduction that mitigates safety concerns without significantly compromising optimized product use potential. This selection process takes into account the specific risk mitigation strategies of the comparator products that may “benchmark” expectations with the FDA (or possibly have been previously mandated by them), with healthcare providers and with payers and their delivery systems.

In the example above, lab tests are generally used to measure drug toxicity, but in this case, the lab test is performed on a periodic basis to ensure that the drug user is not returning to the use of the substance of abuse. Excessively high metabolites of cocaine in the urine would indicate that the patient is attempting to override the blockade of the vaccine. Since lab tests for drug use are frequently part of addiction treatment programs, the intervention is not considered a commercially onerous intervention, although its impact on reducing risk could be significant.

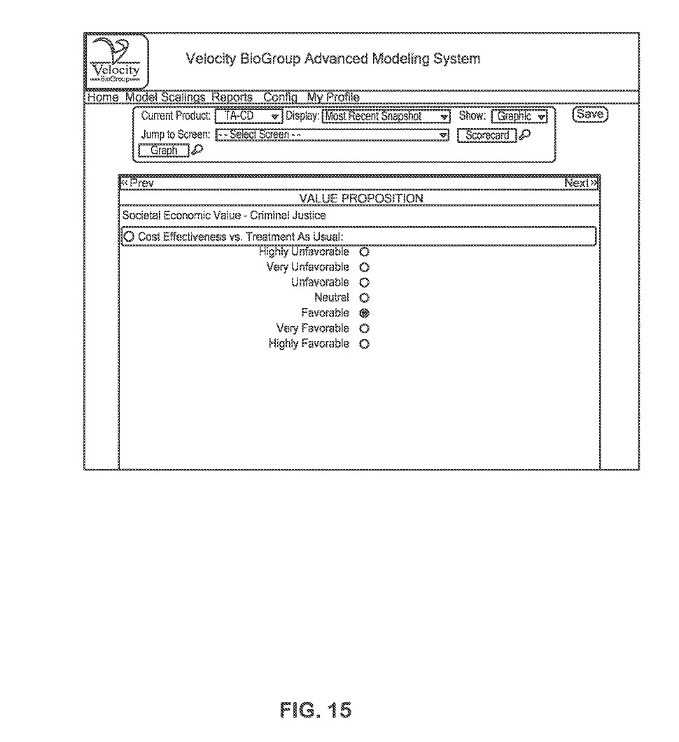

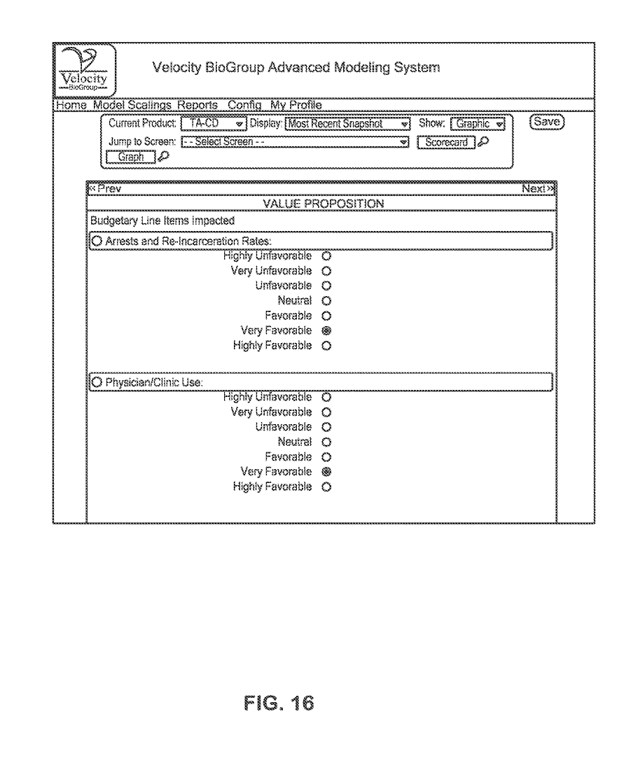

Societal Economic Value (FIGS. 15-16)

The value proposition section considers critical areas where the medical efficacy and safety factors of the asset can be translated into viable value proposition components for payers, health care systems, and patients. This “translation” involves the development of specific tools and secondary clinical trial endpoints that will paint a comparative picture of the asset's capabilities to deliver a specific value proposition relative to that of the competitors under consideration.

In the case of the example presented above, an economic value proposition to payers, particularly in terms of the current standard of care, is best translated by looking at the potential cost effectiveness of TA-CD as compared to the impact of other treatment interventions for substance use disorder. TA-CD has no direct comparators since it could be first to market in this therapeutic class following the research and development pathway. However, since drug abuse is a costly societal problem, the model chooses economic determinants of value in secondary endpoints required during the research and development process to further translate benefits of the product. These will probably be followed in late stage development with more specific translational tools of economic assessment that measure impact on total system expenditures following the use of TA-CD, including “broader” societal costs of reduced criminal justice outlays for crime, treatment, incarceration, and justice system processing.

The value proposition that translates medical efficacy into specific data points using arrest frequency, rates of re-incarceration, and physician or clinic use tracks with value proposition development of other drugs of abuse. These are primarily markers for economic benefit; however, they also represent medical and societal benefit to large payers such as governments (state and federal) and employers. In the case of substance use disorder, federal and state arrests for trafficking and use of illicit drugs is high, creating a considerable financial burden to correctional systems. Therefore, the viability of creating a value proposition around these markers is a strong indication of future marketplace success.

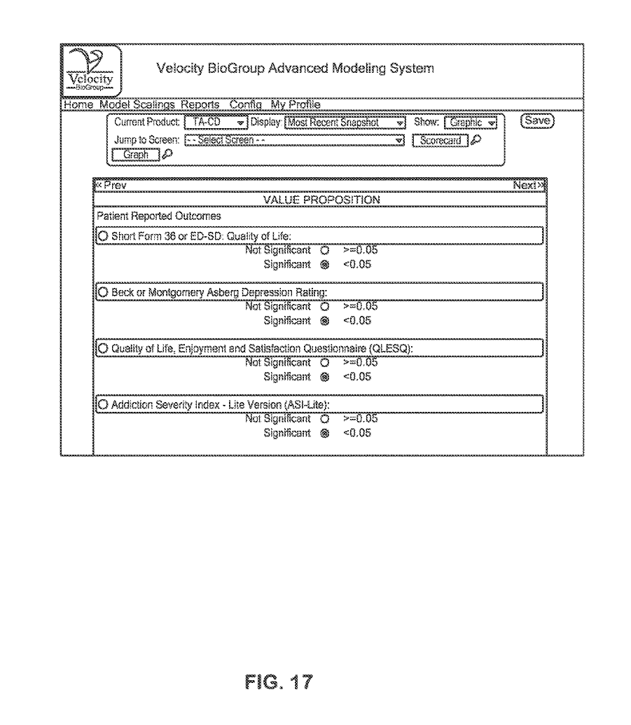

Patient Reported Outcomes (FIG. 17)

Patient (or caregiver) reported outcomes (PROs/CROs) represent a broad spectrum of tools that defines value from the perspective of drug, biologic or medical device users or those who care for these patients. If strategies for using these tools are discussed and negotiated with the FDA at an earlier stage of development, they can be used as part of the promotional label of the biopharmaceutical or device at the time of its approval and thus support commercialization goals. Furthermore, PROs/CROs can support the clinical package by framing the impact of a medical intervention on a patient or caregiver's overall quality of life, including physical, emotional, social, and cognitive impacts.

In the case of TA-CD illustrated above, four tools are used to evaluate these dimensions of quality of life. The SF36, ED50, QLESQ and the ASI Lite are all designed to measure these multi-dimensional elements of patient improvement, with ASI-Lite being specific to addicts. The depression tool is intended to capture the impact of the intervention on quality of life from the perspective of a generalist tool that will evaluate the emotional domain of quality. This tool selection was based on a knowledge of the mechanism of action of TA-CD as well as an understanding of its clinical and stakeholder benefits.

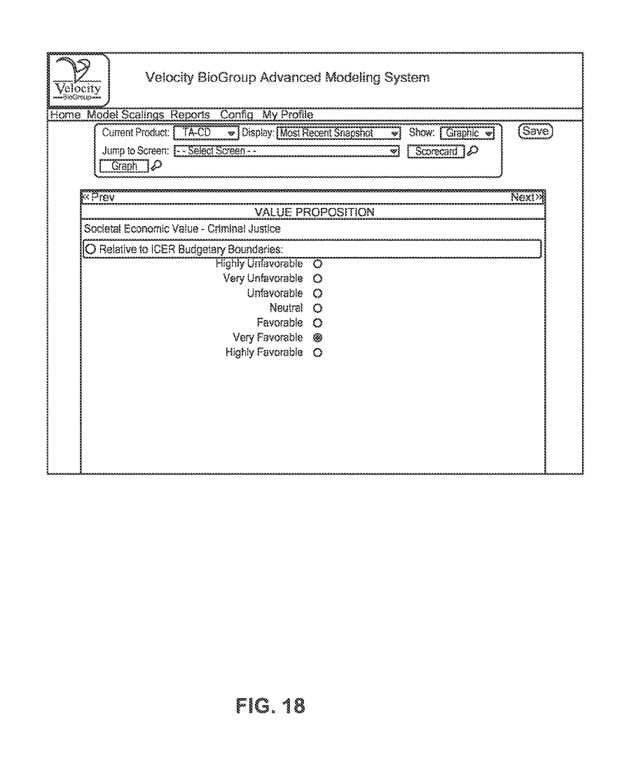

ICER Budgetary Boundaries (FIG. 18)

In the development of the economic value proposition for payers, the software tool supports international as well as US research and development by using the ICER for calculating budgetary constraints in European markets. The ICER is calculated and assessed through NICE in the United Kingdom, which then determines whether their National Health Service will reimburse for the new technology based on its incremental value contribution to their countrywide health care system. The ICER is currently set at approximately US$50,000.

In turn, other European countries will use the results from NICE and make their own translations of this analysis. By considering these budgetary boundaries for product reimbursement and access, the software user can predict whether a value proposition can be developed from the clinical data that can support its commercialization success in a major market beyond the US. The software tool can be customized to reflect many such government or private sector budgetary tools that determine value based on a set of evaluative criteria.

In the case of TA-CD, the “very favorable” rating for ICER reflects the ability of the product to impact medical treatment as well as social costs, especially within the context of the limited options currently in the marketplace.

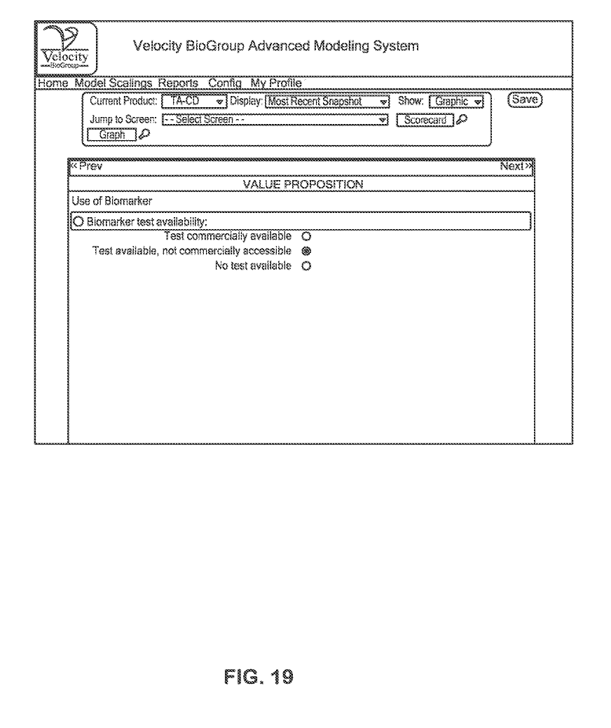

Biomarker Test Availability (FIG. 19)

A biomarker or biological marker is defined as a characteristic that is objectively measured and evaluated as an indicator of normal biological processes, pathogenic processes, or biological responses to a therapeutic intervention. See, Biomarkers Definitions Working Group (2001), Clinical Pharmacology and Therapeutics, 69, pp. 89-95, which is incorporated by reference herein in its entirety. Included in this definition is a genomic biomarker that is a DNA and/or RNA characteristic that is an indicator of normal biological processes, pathogenic processes, and/or response to therapeutic or other interventions.

It is now understood that biomarkers will play a significant role in value proposition development as well as cost-effective innovation delivery. Biomarkers can reduce uncertainty in drug, biologic or device use by providing quantitative predictions about their performance. Biomarkers can translate generalized study results into superior efficacy outcomes and reduced risks for subpopulations revealed by the markers. These can include patient subgroups with specific genetic deficiencies or those with surrogate endpoints revealing predictors for product efficacy or safety failure.

In the case of TA-CD approximately 25% of patients who smoke “crack cocaine” fail to produce specific antibodies for the cocaine vaccine. This is due to the production of natural, non-specified antibodies in response to the hot crack splinters in the lungs of patients that create an innate immunological response. These antibodies however, known as the IgM type, prevent the cocaine antibodies specific to the vaccine from forming and are therefore predictors of a patient subpopulation for whom the vaccine will not be effective.

The biomarker to predict the presence of the IgM antibody type is a simple blood test for its measurement. Given that the vaccine already presents certain challenges for efficacy, the elimination of any factors reducing response rates has enormous significance in the creation of the value proposition. These improved effects on efficacy can, in turn, increase cost effectiveness, patient outcomes, quality of care metrics and payer or reimburser acceptance.

Reimbursement and Administration

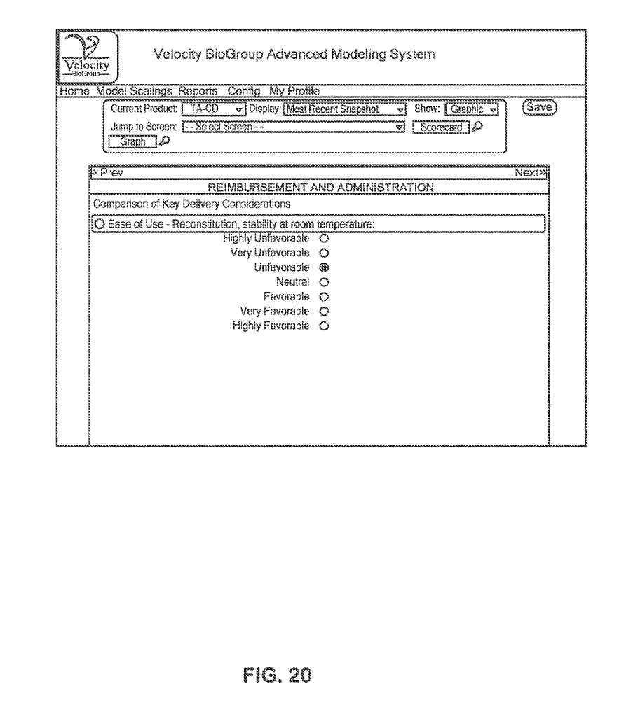

A. Key Delivery Considerations (FIGS. 20-24)

One of the key components of the success of a new technology in the marketplace is the functionality of the product in its delivery system. For a vaccine, this crosses a wide spectrum of delivery considerations including reconstitution and its stability at room temperature (FIG. 20). While many of these factors must be decided early in the research and development process, certain decisions can be made all along the new technology pathway. For example, decisions about critical serotypes that will comprise the medical efficacy, and therefore benefit profile, can have implications on the storage and temperature requirements of the entire formulation. It is critical that awareness of these decisions and potential trade-offs on the medical side of the research process are married with the development side of the business.

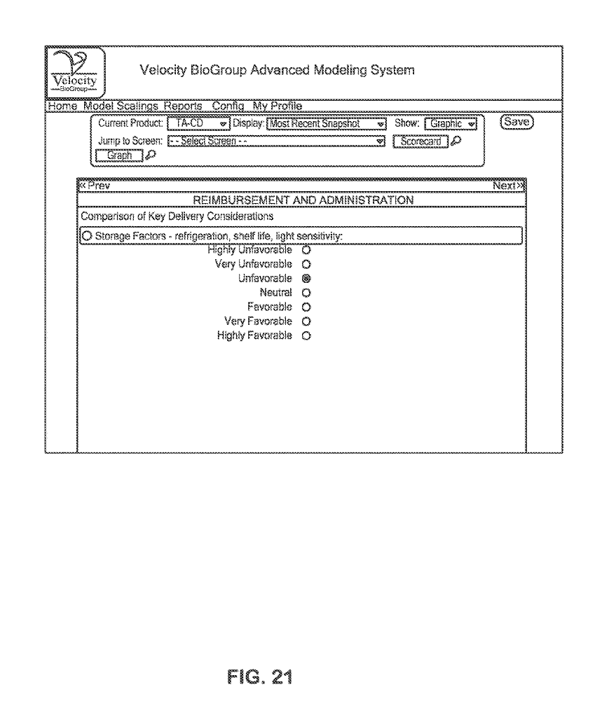

Refrigeration, shelf life, and light sensitivity are factors of concern in comparisons of most injectable versus oral preparations (FIG. 21). This explains why TA-CD (a vaccine) has an unfavorable rating in the measure.

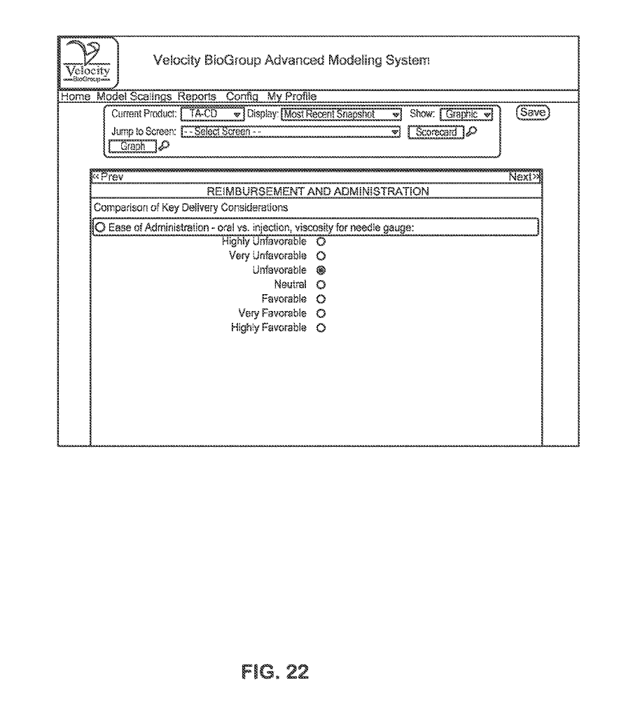

Similarly, the measure of use surrounding the administration by needle versus oral, plus the viscosity of the compound (FIG. 22) which drives needle gauge (and therefore administration trauma!) adversely affects TA-CD versus SUBOXONE in the software prediction, but not against the other injectible comparator, VIVITROL, which requires an extremely large needle to administer a highly viscous solution.

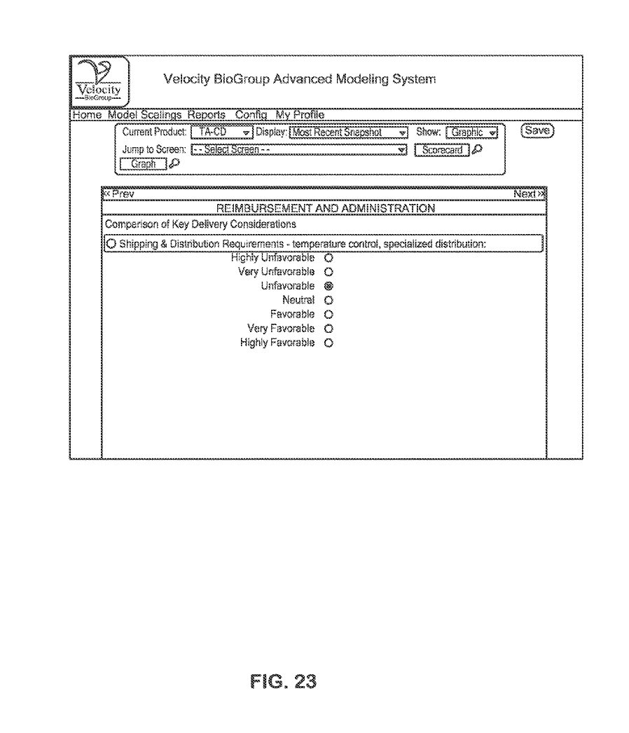

Temperature control during shipping and specialized distribution are important aspects of many injectable products, including vaccines (FIG. 23). These determine costs and complexity relative to oral medications and can increase the commercialization risks. Therefore, as in the case of the software example given here, the rating for TA-CD is unfavorable.

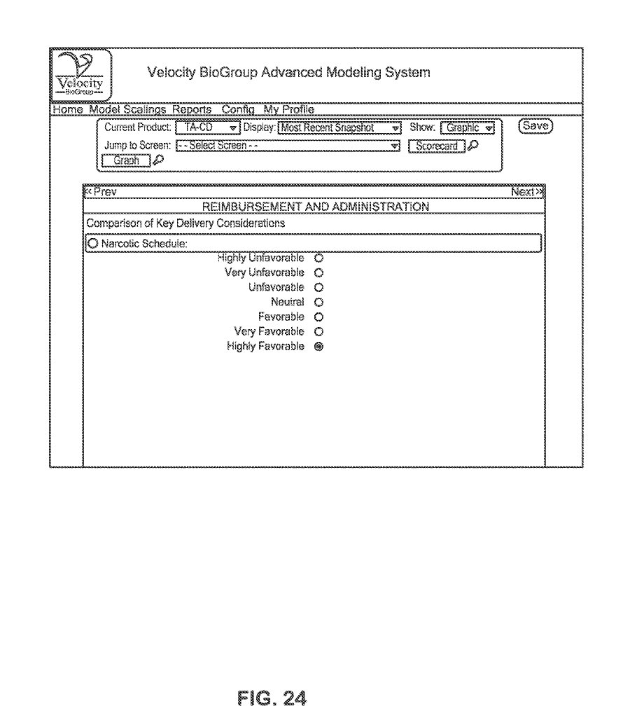

Finally, TA-CD will not require placement on the narcotic schedule, creating a highly favorable rating for this component (FIG. 24). This is important since narcotic scheduling impacts distribution, physician credentialing, and market use. SUBOXONE, one of the comparators, required significant marketplace preparation in order to overcome its status as a narcotic.

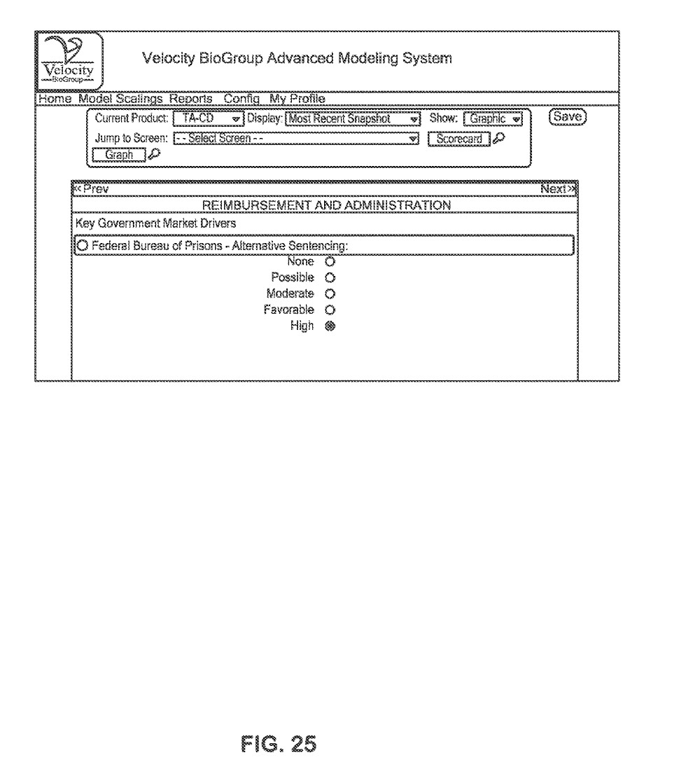

Key Government Market Drivers (FIGS. 25-28)

Predictors for marketplace access are based on the comparator products' access challenges in the same markets. Markets for access are chosen based on the 80/20 rule of looking to key customers who will impact the majority of the business.

In the case of substance use disorder drugs, the core assumption driving the model is that the criminal justice system will be the primary access feeder for TA-CD use. Furthermore, trends towards both federal and state programs that offer treatment versus jail time (i.e., alternative sentencing) will be a significant predictor of the product's commercialization opportunities (FIG. 25).

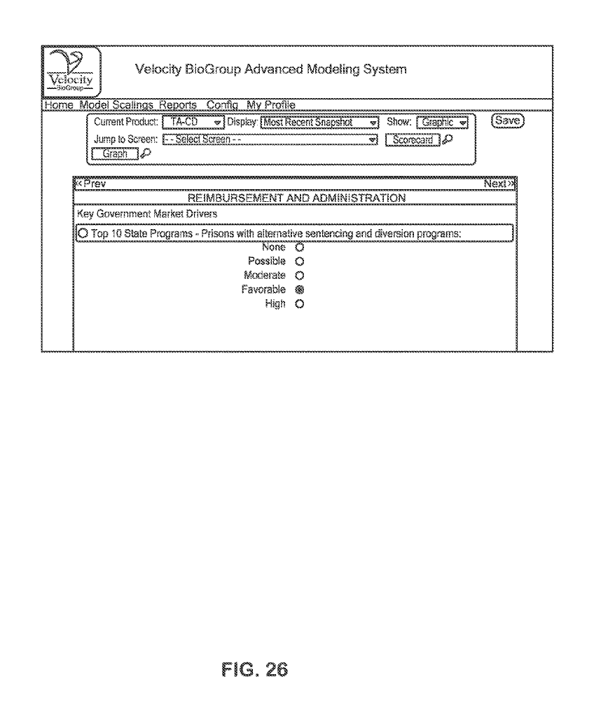

Since 80% of substance abuse treatment is paid through the government, public funding will be critical to the success of any new drug for this disorder. In this example, the top ten states (ranked by population size) are assessed based upon their use of alternative sentencing or diversion programs (FIG. 26). A favorable rating indicates a strong potential market for substance abuse therapies.

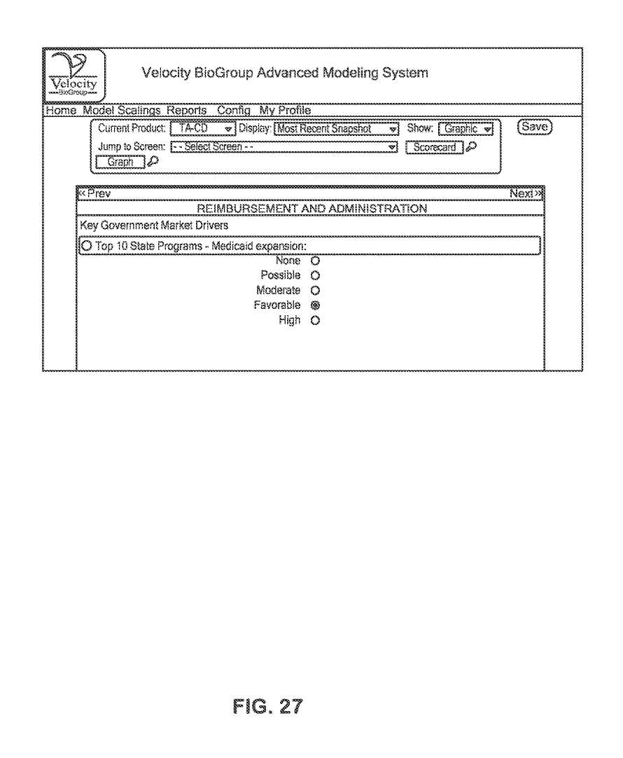

The third screen recognizes that Medicaid is the primary payer for these treatment services, and, in particular, recent changes in the law (e.g., the Patient Protection and Affordable Care Act of 2010) further support that expanded care for low income individuals will provide the funding to pay for these services (FIG. 27). The model captures the top ten programs in Medicaid (by population size) and measures the opportunity for TA-CD success in gaining access as favorable, given its specific profile and the needs of the payer.

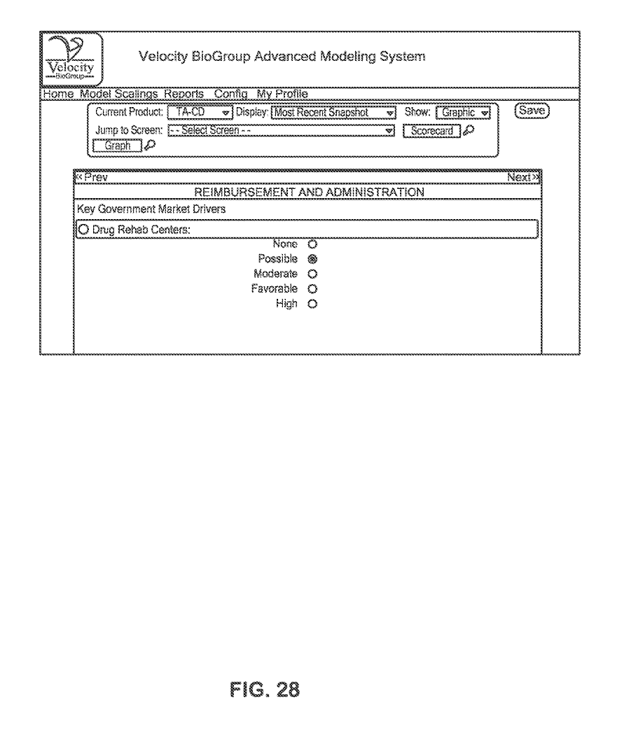

The last screen in the government market basket reflects one point of care delivery, that is, the drug rehabilitation centers (FIG. 28). In reality, these may also represent private sector payer access as well. Rehabilitation centers have more limited durations of stay than the vaccine primary series and booster programs demand (think of the number of shots required for children to get their vaccinations). Consequently, TA-CD has been rated as a “Possible” success within these institutions.

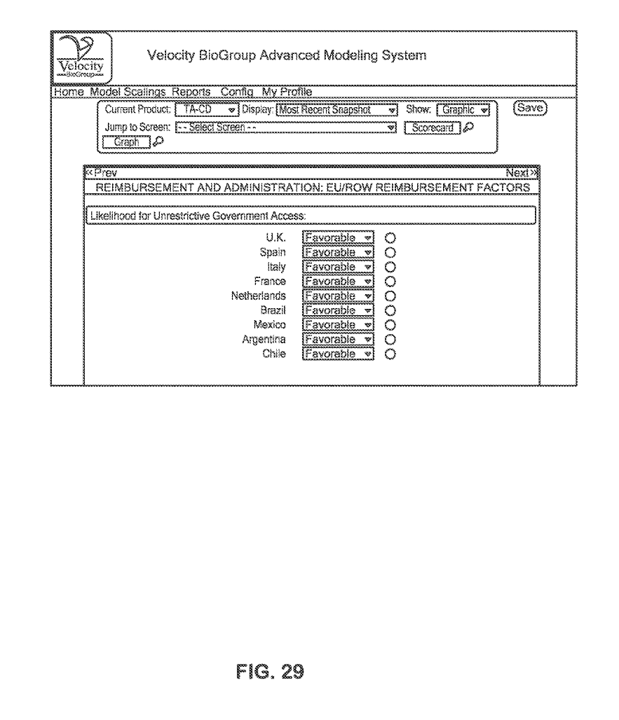

European (EU) and Rest of World (ROW) Access (FIG. 29)

The final screen in the model reflects predictions for specific global markets that can offer commercial viability for TA-CD. In this example, these non-US markets were selected with the epidemiological rates of incidence and prevalence of substance use disorder for cocaine use in mind. All of the selected markets were ranked “Favorable,” reflecting the cost savings advantage of a vaccine versus daily intervention with an oral therapy. Given the extant cost-driven environment, however, making the case for new biologicals will be demanding, which is why the ranking was not “High.” Each country selected had to pass certain criteria for both a “will to treat” and a “will to pay” in order to be ranked “Favorable” in terms of market access.

Part IV: Value Assessment

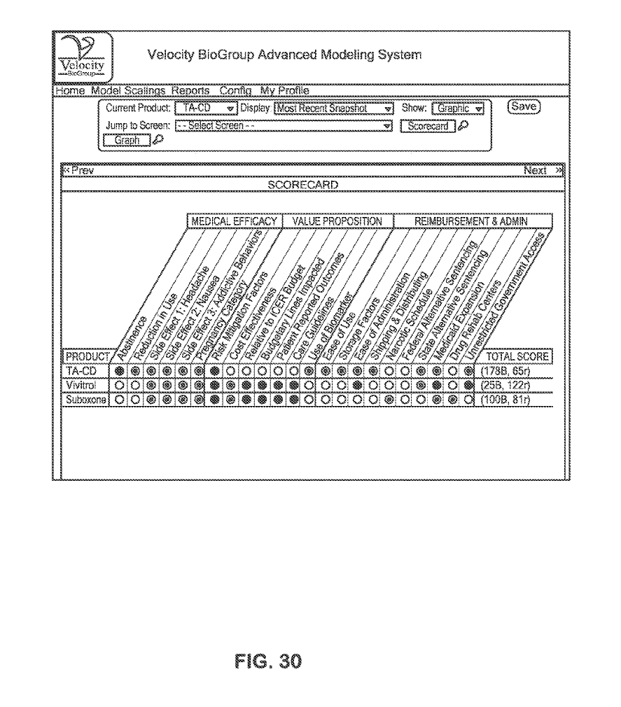

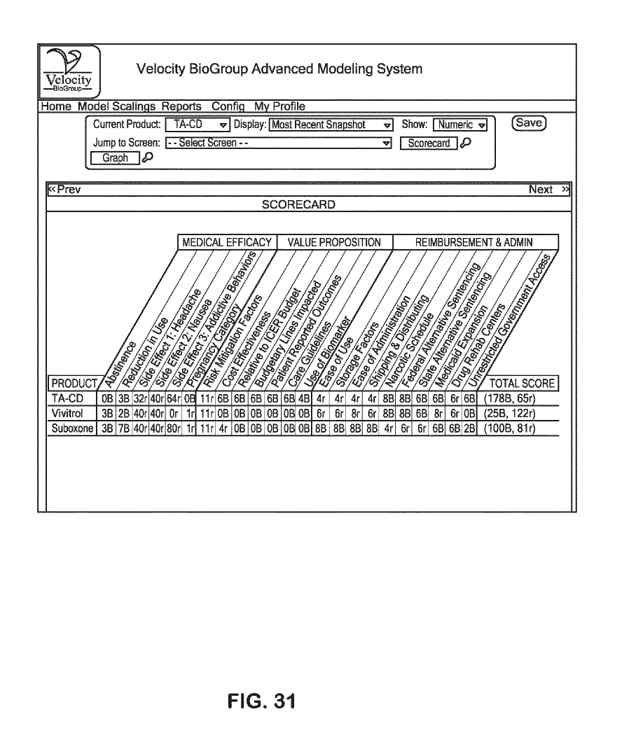

Scorecard (FIGS. 30-31)

As shown in FIG. 30, the scorecard is a compilation of data from the three categories outlined above: drug, biologic or medical device medical benefits and safety risks as presented in research and development or as used for the benchmark comparators, their respective value propositions, and their predictors of marketplace success, with relative scaling factors applied. The scorecard provides a view of the final risk and benefit scores while displaying success and failure indicators for each of the three areas. Indicia, such as color and shape coding, can be used instead of, or in addition to, showing numeric scores. Circles can represent the current scores. The scorecard represents a snapshot in time. As variables change in the model, such as the addition of new clinical trial data, the model instantaneously recalculates the risks and benefits. Changes in color depict changes to the data entered for the product.

The scorecard can also be viewed in a numeric format (as in FIG. 31), providing the user with the benefit and risk scores for each of the data points. The color coding follows the same practice described above. Changes between present and past scorecard ratings can be represented by both color and shape changes. For example, upward and downward arrows can represent an improvement or decline in results from the previous reporting period. A status quo measurement can be represented by circles instead of arrows and fully completed results for any metric can be represented by squares.

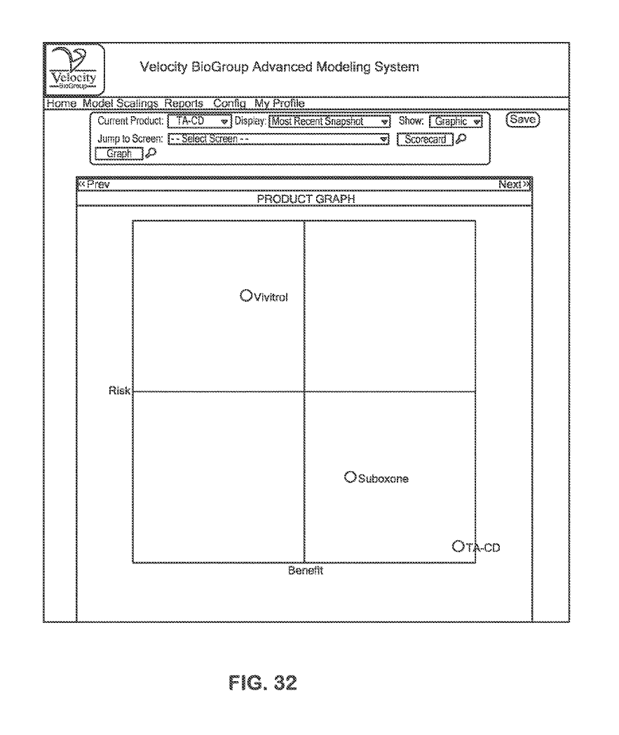

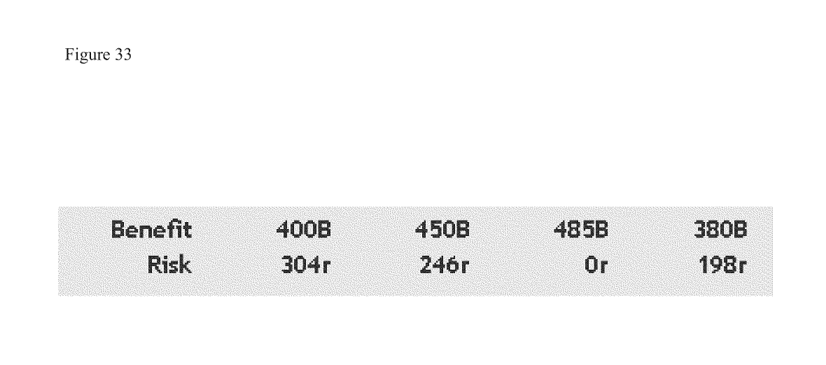

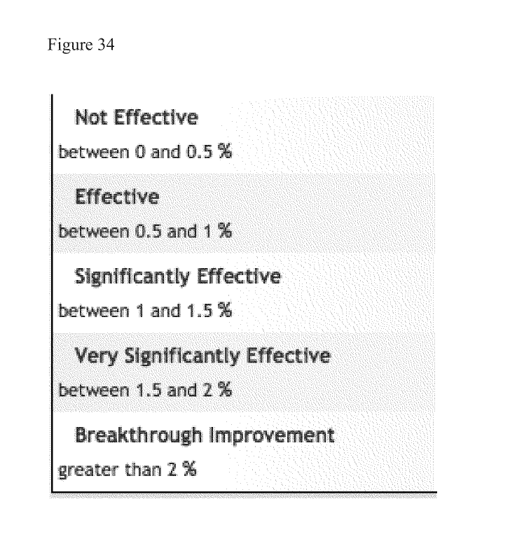

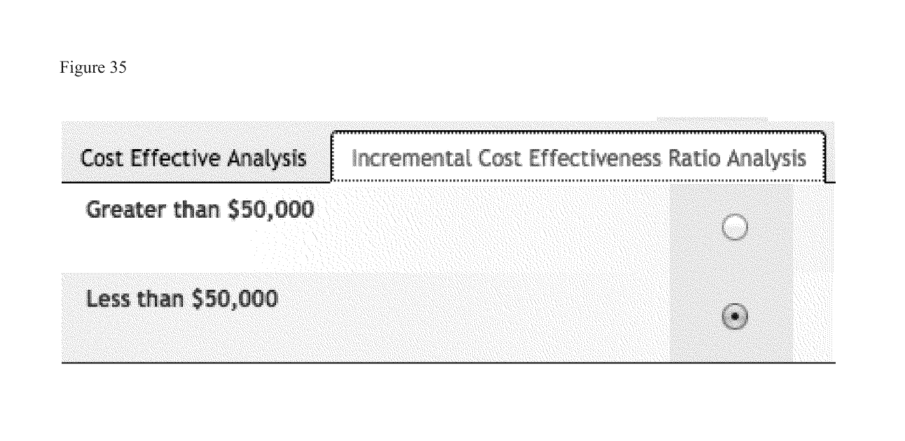

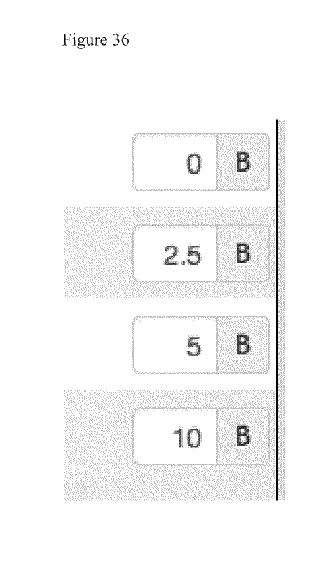

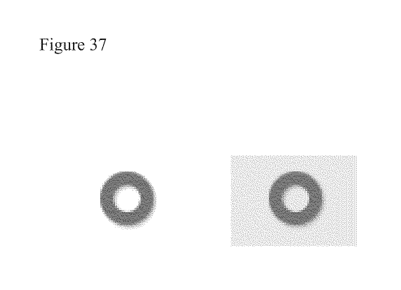

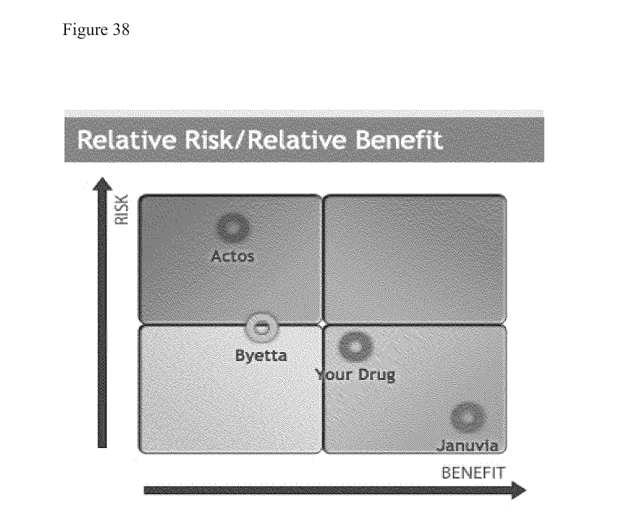

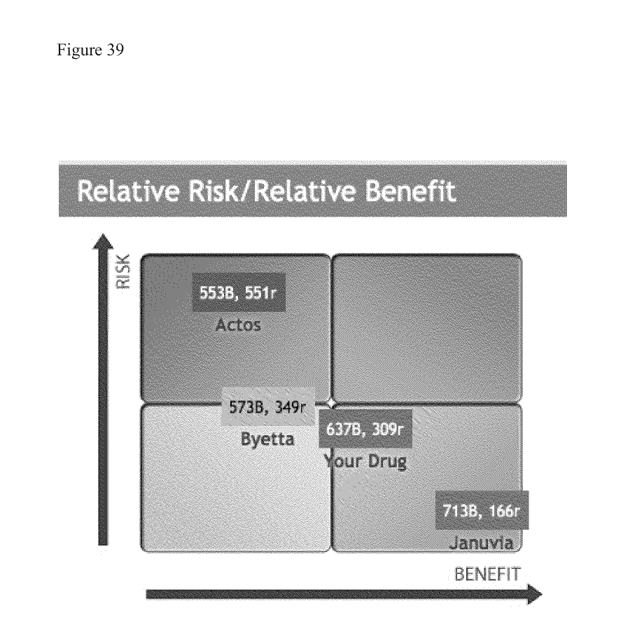

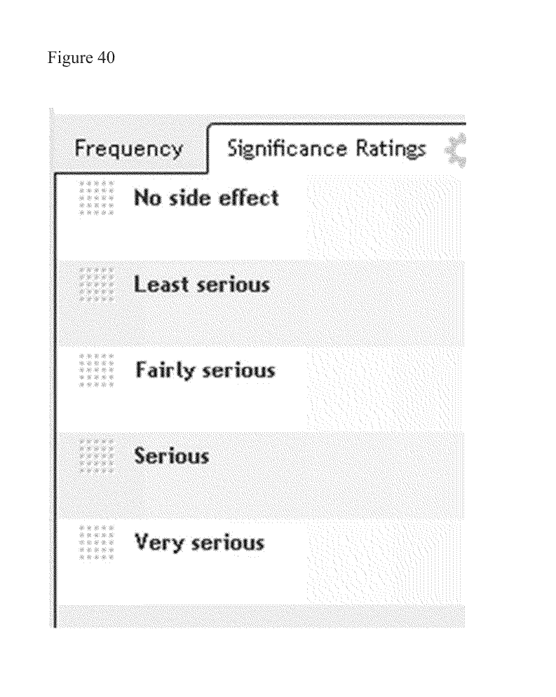

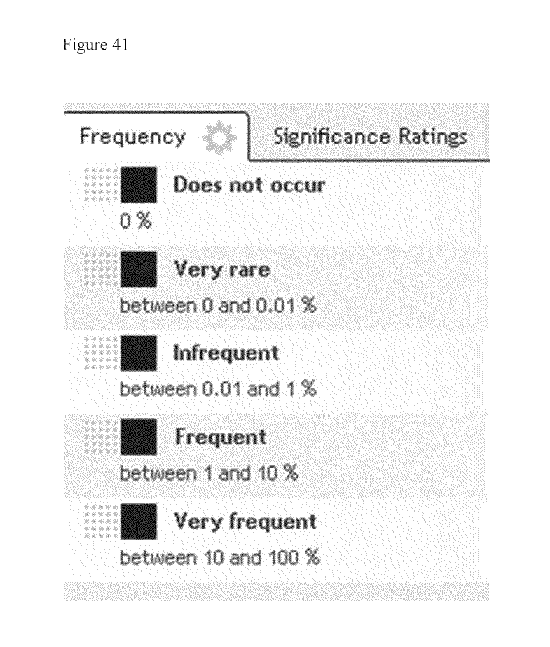

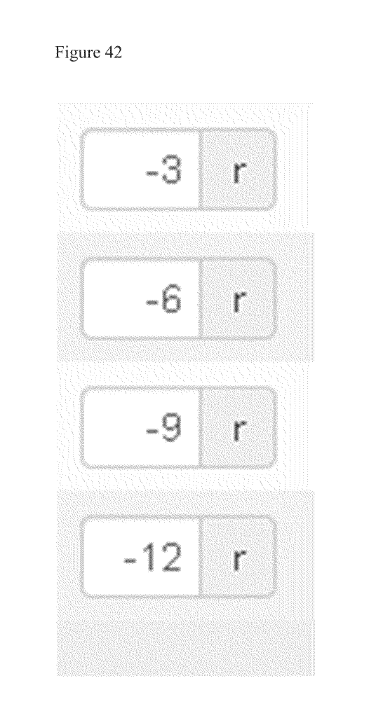

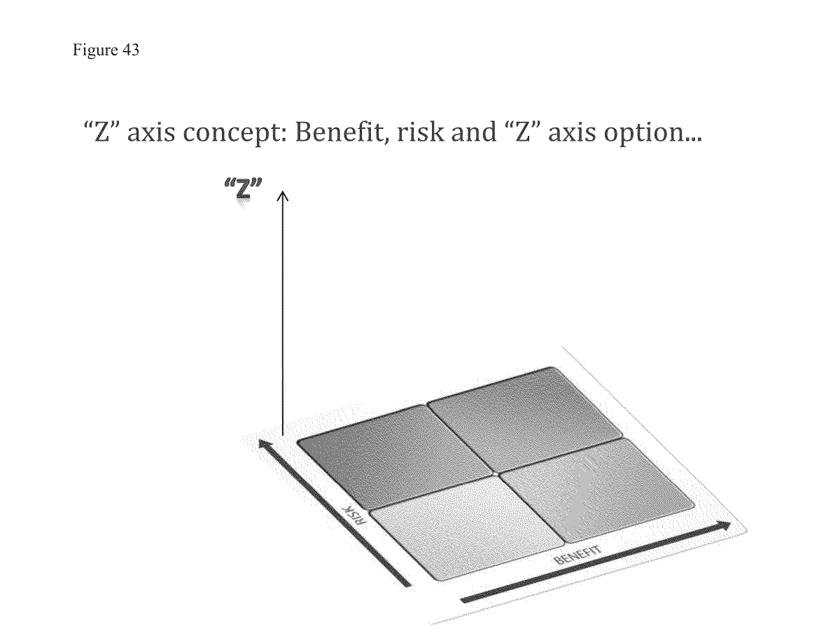

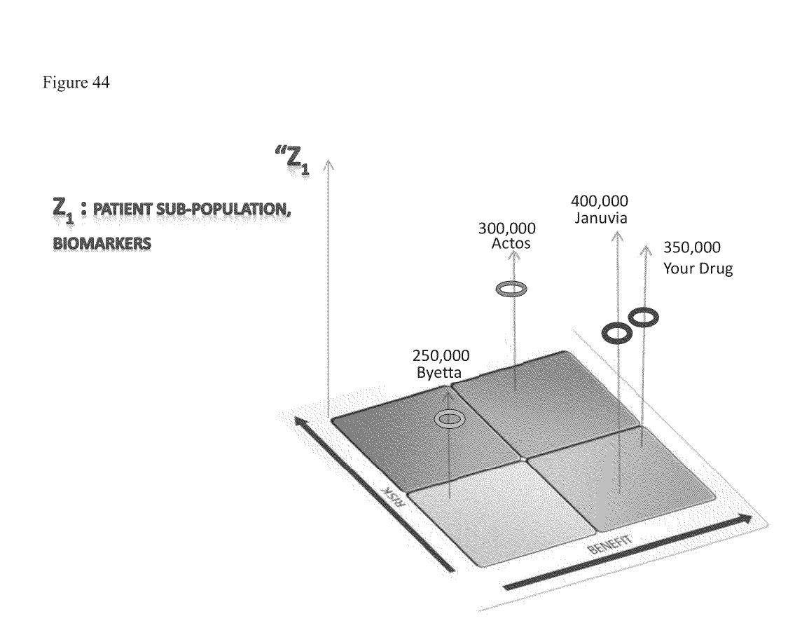

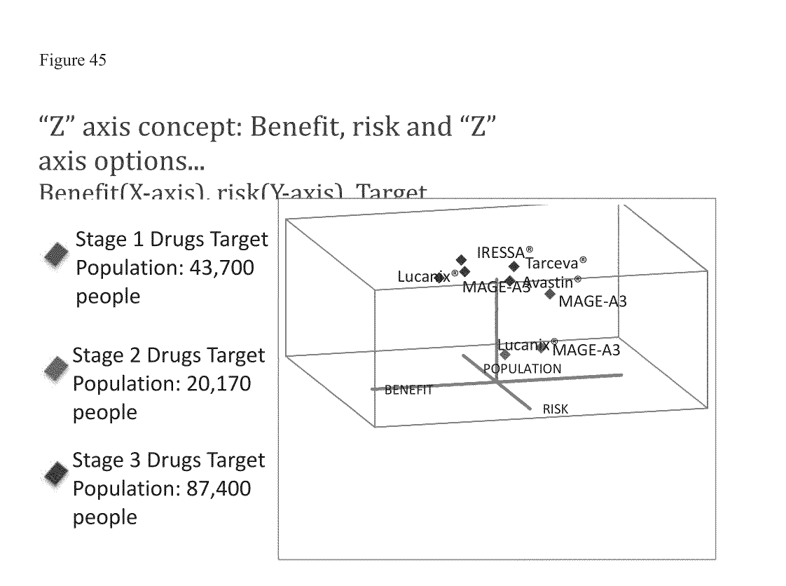

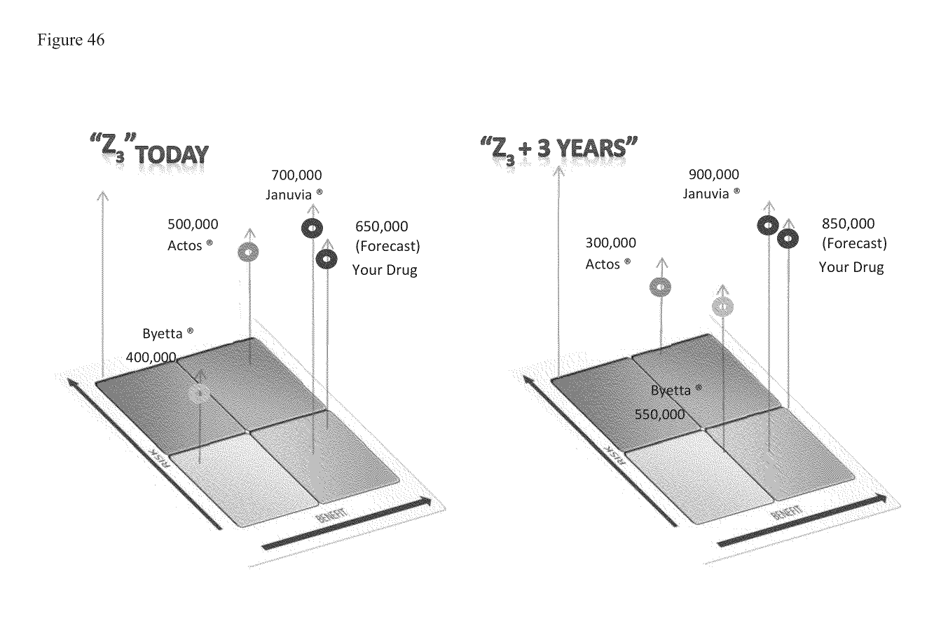

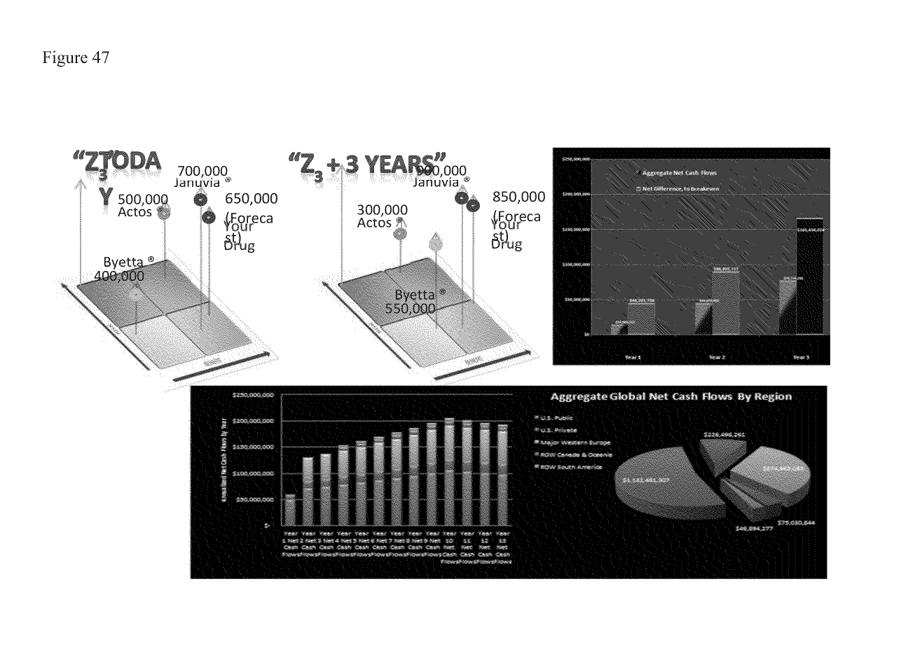

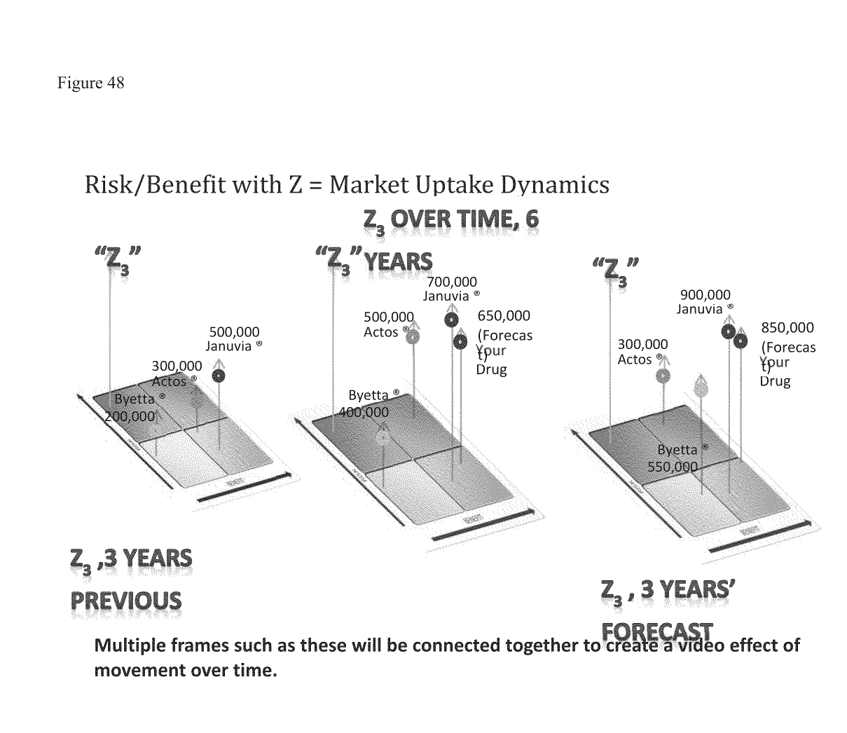

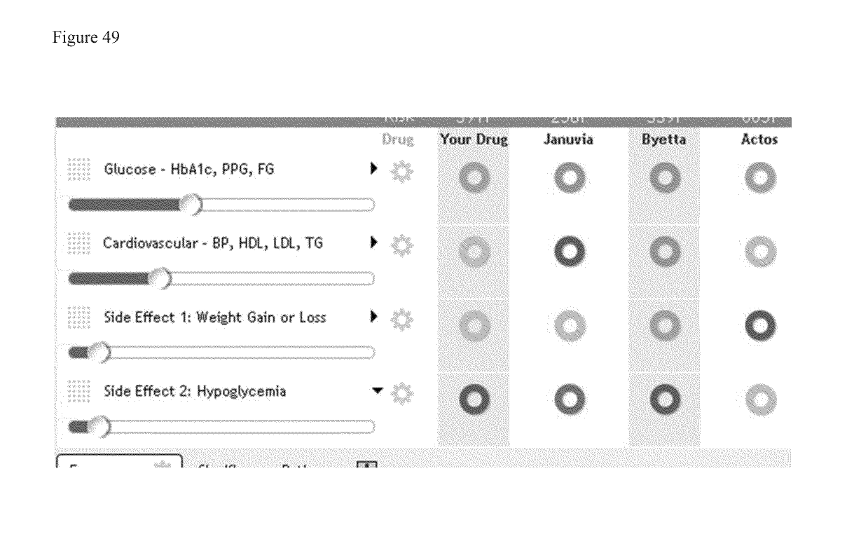

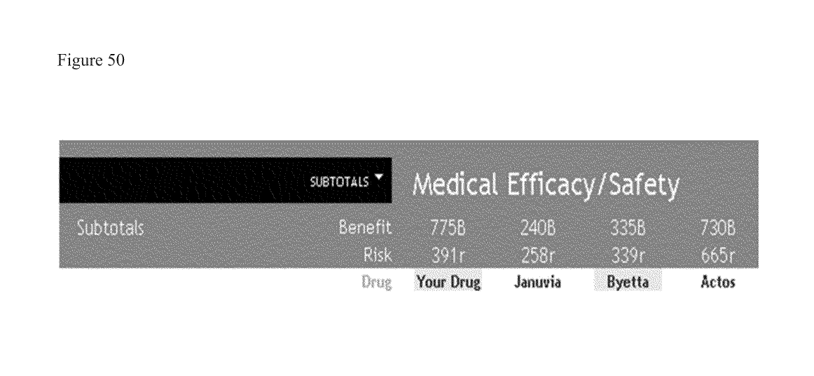

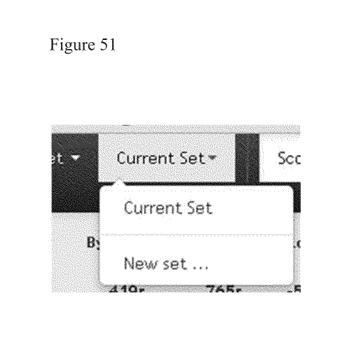

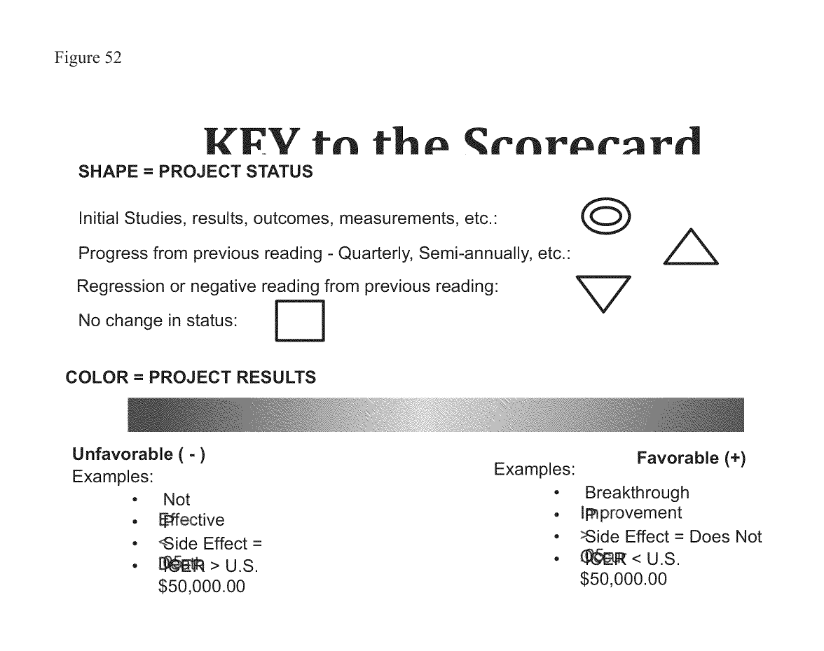

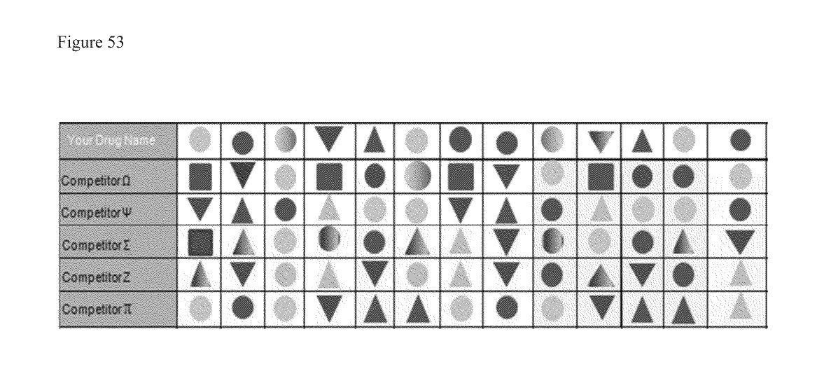

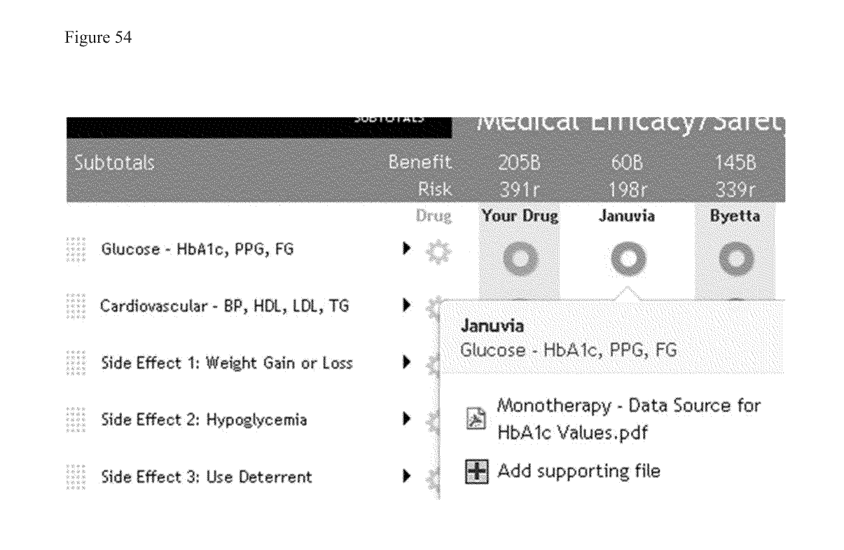

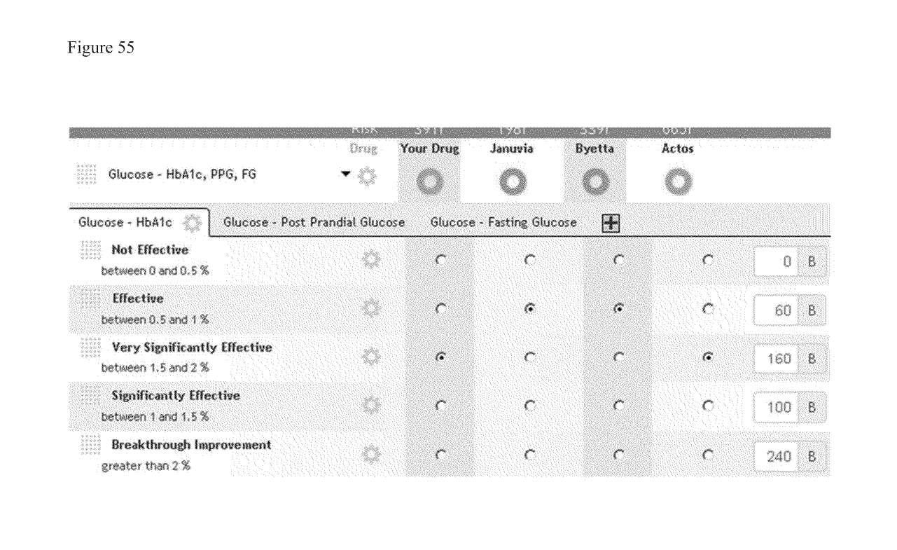

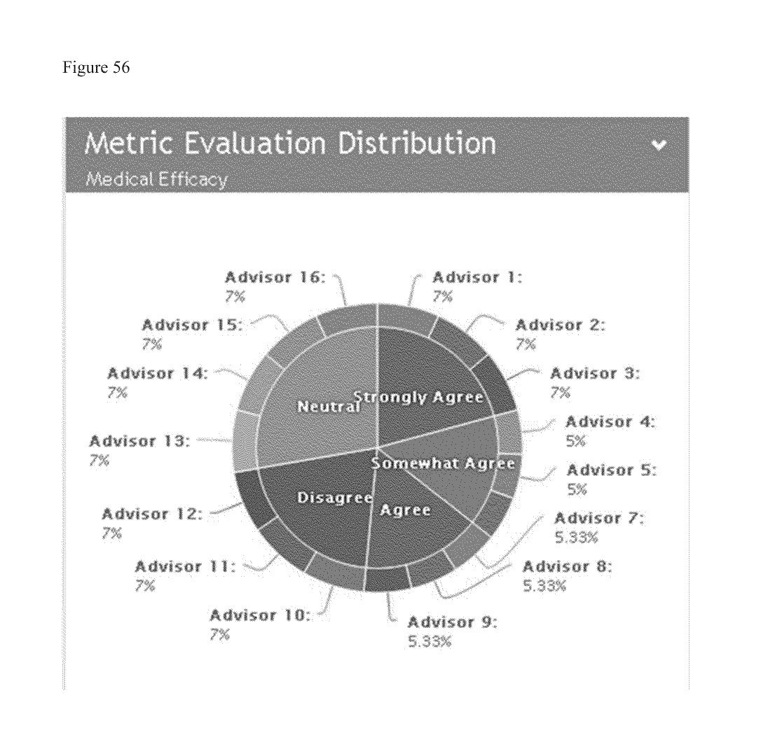

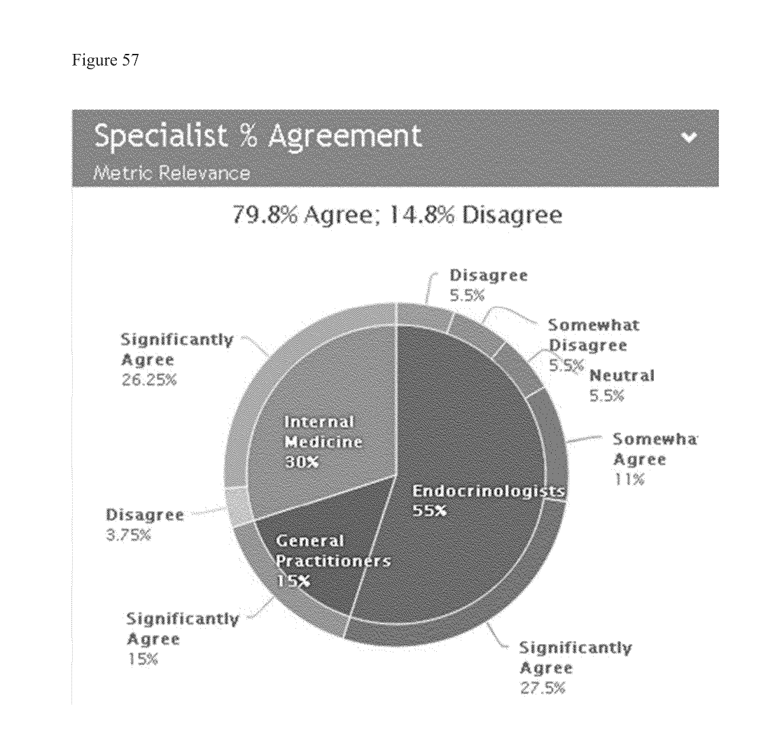

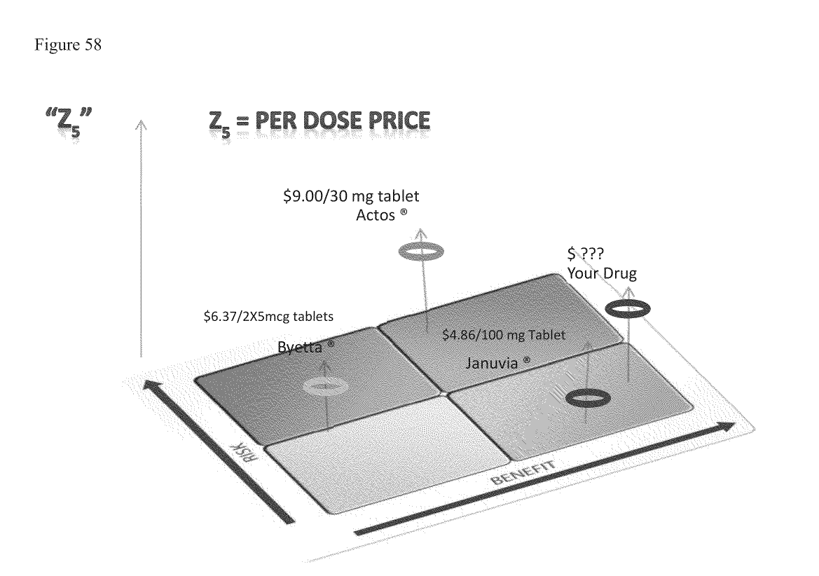

Product Graph (FIG. 32)

The final view of the product's value proposition is depicted on a graph along with the comparators. The y-axis represents the overall risk scores for the product. The x-axis represents the overall benefit scores. The ideal location for the product is in the bottom right quadrant of the graph, where benefit is high and risk is low. The graph shows the relative value proposition for each product and also provides guidance for product price points in the market.

The graph is defined as an “X” and “Y” coordinate two-dimensional graph, located in Quadrant 1 of the Cartesian plane convention, which has four quadrants. Risk is considered a negative characteristic, usually placing it as the second coordinate of the convention (x, y) along the negative y-axis below the zero point. However, given the concern for “rising” or “intensifying” risk factors, and how analysts and reviewers typically refer to a “rising risk”, using the y-axis above the zero point fits that idea. Therefore, although not technically accurate, we will use that commonly-referenced convention. Most government and business convention demands use of Quadrant 1 to explain ideas while referencing a graph/Cartesian coordinate using (x, y) coordinate graphs.

Market positioning on the graph is accomplished by setting an overlay of two lines in Quadrant 1 as illustrated. The midpoints are the average of the benefit scores of the existing market or proxy products for the x-axis and the average of the risk scores for the y-axis. The new market product's scores are not included in either of these average value calculations. The existing products are then positioned on the graph from their benefit scores as the x component and the risk scores as the y component. In addition, it will be observed that their positioning will also be relative to the average value lines of benefit and risk, either above or below, or to the right or left of these lines. This then sets the average values and outer boundaries of the market as it exists and how the marketed products therein are currently positioned for commercialization success.

Finally, the new market product x value is its Benefit score and its y value is derived from its risk score. These are then used to locate its position on quadrant 1, relative to A) the existing market products, B) the secondary lines, and C) the existing market product benefits and risks. This visual display provides added clarity for future pricing of the drug, biologic or medical device in research and development and justifies the further investment in the product's continued program.

Part V: Summary

A primary purpose of the evaluative tool described herein is to support the assessment of drugs, biologics and medical devices during research and development in order to make critical decisions for an optimized research and development pathway to commercialization and for assessing the feasibility of continued investment. This decision making can be facilitated by automating a great number of actual and theoretical clinical trial, value proposition and marketplace success predictors in order to forecast best and worst case scenarios for meeting a target product profile. This software tool is the first to measure, weight, and integrate all of the critical factors that come into play in the development of a risk/benefit profile of a technology in development relative to its currently marketed competitors, benchmarked around their multiple endpoints for success, in order to determine the new technology's research, development and commercialization viability.

While certain concepts may have been described, such as Medical Efficacy/Safety, Value Proposition, and Market Uptake Predictors, other comparable concepts could also be used instead of or in addition to those concepts, such as Equipment Efficacy/Safety and Market Service.

In the case of the user—health economist, pharmacist or physician—metrics are chosen and scored (sometimes weighted) to ascertain best health care choices or to predict the effectiveness of interventions or assessments. In the case of the chooser, even after approval, resources are allocated towards the effective use or development of the product by assessing its drivers for market success/commercialization.

The benefits of the software tool over existing technologies are many:

Provides for a consolidation of large amounts of data into a simplified dashboard for critical decision-making in drug, biologic and medical device research and development, thus eliminating the need for unnecessary paperwork and uncontrolled and unmeasured processes;

Defines and distills the risk/benefit ratio of multiple research and development alternatives for drugs, biologics and medical devices into easy-to-understand factors that can be translated into scoreable metrics;

Allows for easy and early recognition of critical factors supporting or challenging the successful achievement of a target product profile, that is the strategic plan for a drug, biologic or medical device in research and development, that charts the necessary thresholds of success needed for continuing program investment;

Creates a comprehensive comparative effectiveness framework for evaluating drug, biologic or medical device candidates for financing, research, development, acquisition or utilization by biopharma or medical device companies, healthcare system payers or innovation financiers.

Allows for a competitive analysis of drugs, biologics or medical devices currently in research and development, relative to the current standard of care, or relative to those products that have proven the greatest marketplace or stakeholder acceptance.

Positions new assets in research and development for the most likely overall research, development and marketplace success, based on the track record of either competitors or market surrogates with the same marketplace criteria, value proposition development and stakeholder community interests.

Graphically displays in three dimensions (plus time) the commercial viability of drugs, biologics or medical devices in research and development on an x-y axis for benefit and risk, and Z axis for increasing target populations, market uptake or growth in uses.

Employs a real-time scenario planning function to model various what-if research and development scenarios for forecasting the likely attainment of the target product profile. The tool does not select a single “best path” for optimized research and development but instead models a number of possible benefit achievements or risk containments to optimize the decision making process.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed:

1. A computer-implemented method for evaluating a drug, biologic or medical device in research and development or in assessing the feasibility of continued investment, the method comprising:
using a computerized processor for:
defining a maximum benefit numerical score representing total benefits of a drug, biologic or medical device based on clinical trial data;
defining a maximum risk numerical score representing total risks of the drug, biologic or medical device based on clinical trial data;
receiving scaled adjustment values associated with identified model categories, wherein the scaled adjustment values represent importance of factor elements within a model category;
apportioning the maximum benefit numerical score among the identified model categories based on the scaled adjustment values associated with the model categories;
apportioning the maximum risk numerical score among the identified model categories based on the scaled adjustment values associated with the model categories;
receiving an identification of one or more factor elements defined within one or more of the model categories;
receiving a plurality of risk scores and benefit scores for the identified factor elements;
generating an overall numerical benefit score based on the aggregate of the benefit scores for the identified factor elements as adjusted by the scaled adjustment values associated with the model categories;
generating an overall numerical risk score based on the aggregate of the risk scores for the identified factor elements as adjusted by the scaled adjustment values associated with the model categories;
storing the overall numerical risk and overall numerical benefit scores for the drug, biologic or medical device as separate benefit and risk values in a computerized storage device; and
displaying the stored overall scores on one or more axes.

2. The method of claim 1, wherein a feasibility evaluation is reviewed by a convened panel of relevant category experts in terms of a range of qualitative values, the values represent one or more descriptors selected from the group comprising: substantially disagree to substantially agree, efficacy breakthrough to not effective, side effect not present or very serious, product cost effective to not cost effective, formulation or dosing desirable or not desirable, assessment of relevant worth of a factor from category experts' perspective; and
incorporating those results as part of the feasibility evaluation.

3. The method of claim 1, wherein a feasibility evaluation is reviewed by a convened panel of relevant category experts in terms of the value of the factors as represented by a scale of their importance in a model category relative to each other.

4. The method of claim 1, wherein a feasibility evaluation is reviewed by a convened panel of relevant category experts in terms of the relative apportioning of the model categories to each other.

5. The method of claim 1, wherein the overall numerical risk and overall numerical benefit scores represent a feasibility of the drug, biologic or medical device to meet regulatory approval and achieve commercialization success.

6. The method of claim 1, wherein the adjustment values associated with the model categories comprise one or more multipliers.

7. The method of claim 1, further comprising creating a two-dimensional representation of the overall numerical risk and overall numerical benefit scores.

8. The method of claim 1, wherein the overall numerical risk and overall numerical benefit scores are predictive of commercialization success of the drug, biologic or medical device.

9. The method of claim 1, wherein the overall numerical risk score represents a market risk to a developer of the drug, biologic or medical device.

10. The method of claim 1, further comprising presenting a graphical comparative display of a plurality of drugs, biologics or medical devices in relation to each other in a two dimensional space, wherein a first dimension represents an overall numerical risk and a second dimension represents an overall numerical benefit of each of the drugs, biologics or medical devices.

11. The method of claim 1, further comprising receiving a qualitative descriptor representing quantitative clinical trial data for scoring benefit and risk.

12. The method of claim 11, wherein the qualitative descriptor is selected from a plurality of predefined effectiveness, value, or significance ratings for a drug, biologic or medical device under development.

13. The method of claim 1, wherein each of the model categories further comprises multiple factor elements.

14. The method of claim 1, wherein each of the model categories available for identification is dependent upon the drug, biologic or medical device, and the therapeutic area for which that drug, biologic or medical device is intended.

15. The method of claim 1, wherein benefit and risk are assigned specific definitions and then assigned to a holistic scoring system for a plurality of drugs, biologics or medical devices that measures the likelihood of commercialization or marketplace success from product inception through marketplace adoption.

16. The method of claim 1, further comprising presenting a graphical comparative display of a plurality of drugs, biologics or medical devices in relation to each other in a three dimensional space, wherein a first dimension represents an overall numerical risk and a second dimension represents an overall numerical benefit and a third dimension represents either a target population of product use, a specific medical indication, a market uptake pattern, trend or forecast or an expected return on investment for each of a plurality of drugs, biologics or medical device under development consideration.

17. The method of claim 1, further comprising presenting a graphical comparative display of a plurality of drugs, biologics or medical devices in relation to each other in a four dimensional space, wherein a first dimension represents an overall numerical risk and a second dimension represents an overall numerical benefit and a third dimension as depicted through a Z-axis represents either a target population of product use, a specific medical indication, a market uptake pattern, trend or forecast or an expected return on investment and the fourth dimension expressing the passage of time in a multi-frame representation. The multi-frame representation will demonstrate the increasing population size, medical uses, market uptake, or return on investment of a plurality of drugs, biologics or medical devices demonstrated in the third dimension.

18. The method of claim 1, wherein scores for categories can be anticipated using the computer-implemented method in advance of the score realization. The tool allows the user to forecast various scenarios in advance of the actual achievement of the scores in order to anticipate best and worst case research and marketplace results and therefore plan accordingly. This planning also includes overall environmental assessments wherein different critical factors and/or the categories in which they are classified can be weighted or apportioned differently to reflect evolving scenarios which present themselves over the long course of the product life cycle.

19. The method of claim 1, wherein graphical representation illustrates research and marketplace planning alternatives can be plotted and visualized through automated icon or numerical movement into the red, orange, yellow and green quadrants, capturing the meaning of traffic light color-coding for advancing, slowing or stopping developers' research and market planning. These icon movements for tracking research, development and new product marketing progress or setbacks in drug, biologic and medical device development are captured on old and new screen shots that can be saved as reference documents in the program.

20. The method of claim 1, wherein the total calculated and apportioned scores for benefits and risks of a plurality of comparator drugs, biologics and medical devices, with known market pricing, can be used to calculate the comparative market price of a new product in development using a relational algebraic formula that ties the known pricing to Benefit/risk scores and specific prices.

21. A computer-implemented method for evaluating a drug, biologic or medical device in research and development or in assessing the feasibility of continued investment, the method comprising:
using a computerized processor for:
defining a maximum benefit numerical score representing total benefits of a drug, biologic or medical device based on clinical trial data;
defining a maximum risk numerical score representing total risks of the drug, biologic or medical device based on clinical trial data;
apportioning the maximum benefit numerical score among identified model categories;
apportioning the maximum risk numerical score among the identified model categories;
receiving an identification of one or more factor elements defined within one or more of the model categories;
receiving a plurality of risk scores and benefit scores for the identified factor elements;
receiving scaled adjustment values associated with the identified factor elements, wherein the scaled adjustment values represent the importance of factor elements within a model category;
generating an overall numerical benefit score based on the aggregate of the benefit scores for the identified factor elements as adjusted by the scaled adjustment values associated with the identified factor elements;
generating an overall numerical risk score based on the aggregate of the risk scores for the identified factor elements as adjusted by the scaled adjustment values associated with the identified factor elements;
storing the overall numerical risk and overall numerical benefit scores for the drug, biologic or medical device as separate benefit and risk values in a computerized storage device; and
displaying the stored overall scores on one or more axes,
wherein the overall scores represent a likelihood of commercialization or marketplace success from product inception through marketplace adoption.

22. The method of claim 21, wherein a feasibility evaluation is reviewed by a convened panel of relevant category experts in terms of a range of qualitative values ranging from substantially disagree to substantially agree, and incorporating those results as part of the feasibility evaluation.

23. The method of claim 21, wherein the overall numerical risk and overall numerical benefit scores represent a feasibility of the drug, biologic or medical device to meet regulatory approval and achieve commercialization success.

24. The method of claim 21, further comprising presenting a graphical comparative display of a plurality of drugs, biologics or medical devices in relation to each other in a two dimensional space, wherein a first dimension represents an overall numerical risk and a second dimension represents an overall numerical benefit of each of the drugs, biologics or medical devices.

25. A computer system for evaluating a drug, biologic or medical device in research and development or in assessing the feasibility of continued investment, the system comprising
an input device;
an output device;
a processor configured for:
defining a maximum benefit numerical score representing total benefits of a drug, biologic or medical device based on clinical trial data;
defining a maximum risk numerical score representing total risks of the drug, biologic or medical device based on clinical trial data;
receiving scaled adjustment values associated with identified model categories, wherein the scaled adjustment values represent importance of factor elements within a model category;
apportioning the maximum benefit numerical score among the identified model categories based on the scaled adjustment values associated with the model categories;
apportioning the maximum risk numerical score among the identified model categories based on the scaled adjustment values associated with the model categories;
receiving an identification of one or more factor elements defined within one or more of the model categories;
receiving a plurality of risk scores and benefit scores for the identified factor elements;
generating an overall numerical benefit score based on the aggregate of the benefit scores for the identified factor elements as adjusted by the scaled adjustment values associated with the model categories;
generating an overall numerical risk score based on the aggregate of the risk scores for the identified factor elements as adjusted by the scaled adjustment values associated with the model categories;
storing the overall numerical risk and overall numerical benefit scores for the drug, biologic or medical device as separate benefit and risk values in a computerized storage device; and
displaying the stored overall scores on one or more axes.

26. The system of claim 25, wherein the adjustment values associated with the model categories comprise one or more multipliers.

27. The system of claim 25, further comprising creating a two-dimensional representation of the overall numerical risk and overall numerical benefit scores.

28. The system of claim 25, wherein the overall numerical risk and overall numerical benefit scores are predictive of commercialization success of the drug, biologic or medical device.

29. The system of claim 25, wherein a sum of total B and r score in the model can be apportioned with a more significant emphasis on the ratio of the B score relative to r score in a weighting of the model representing a multiplication up or division down of either score to represent an appropriate risk benefit ratio for the therapeutic class in review.

30. The system of claim 25, wherein the scorecard provides a view of the final risk and benefit scores while displaying success and failure indicators for each of the three areas and indicia, such as color and shape coding, can be used instead of, or in addition to, showing numeric scores.

31. The system of claim 25, wherein the midpoints are the average of the benefit scores of the existing market or proxy products for the x-axis and the average of the risk scores for the y-axis.
